(19) United States
(12) Patent Application Publication
(10) Pub. No.: US 2025/0321787 A1
(43) Pub. Date: Oct. 16, 2025

(54) METHODS AND APPARATUS TO DISTRIBUTE WORKLOADS IN SERVER FARMS BASED ON TEMPERATURE

(71) Applicant: Intel Corporation, Santa Clara, CA (US)

(72) Inventors: Rodrigo Aldana Lopez, Zapopan (MX); Leobardo E. Campos-Macías, Guadalajara (MX); Sandra Elizabeth Coello Chavarin, Zapopan (MX); Hector Alfonso Cordourier Maruri, Guadalajara (MX); Diego Mauricio Cortes Hernandez, Hillsboro, OR (US); Oscar Alejandro Del Rio Gonzalez, Guadalajara (MX); David Gomez Gutierrez, Zapopan (MX); Evelyn Gonzalez Hernandez, Zapopan (MX); Alejandro Ibarra Von Borstel, Buda, TX (US); Margarita Jauregui Franco, Zapopan (MX); Paulo Lopez Meyer, Guadalajara (MX); Edgar Macias Garcia, Guadalajara (MX); Rosa Jacqueline Sanchez Mesa, Zapopan (MX); Julio Cesar Zamora Esquivel, West Sacramento, CA (US)

(73) Assignee: Intel Corporation, Santa Clara, CA (US)

(21) Appl. No.: 19/247,302

(22) Filed: Jun. 24, 2025

(51) Int. Cl. G06F 9/48

(52) U.S. Cl. CPC G06F 9/4893

(57) ABSTRACT

Systems, apparatus, articles of manufacture, and methods to distribute workloads in server farms based on temperature are disclosed. An example first compute device includes at least one programmable circuit to at least one of instantiate or execute machine readable instructions to: analyze temperature data indicative of a first temperature of a first compute device and a second temperature of a second compute device; and cause an adjustment in at least one of a first workload executed by the first compute device or a second workload executed by the second compute device based on the temperature data, the adjustment to reduce a difference between the first and second temperatures.

### BACKGROUND

Electronic components, such as microprocessors and integrated circuit packages, generally produce heat during operation. Excessive heat may degrade the performance, reliability, and/or life expectancy of such electronic components and may even cause component failure. Accordingly, in many instances, cooling systems are implemented to dissipate heat from such electronic components to maintain the operational temperature of such components within a suitable range. Server farms (e.g., data centers) often include many servers containing such electronic components arranged in racks that produce significant amounts of heat. Accordingly, in addition to cooling systems (e.g., fans) specific to each individual server, server farms also implement building-level cooling systems to help cool the ambient air temperature within the enclosure (e.g., room, building, etc.) containing the heat producing servers.

### BRIEF DESCRIPTION OF THE DRAWINGS

FIG. 1 is a schematic representation of an example server cluster in a server farm that implements teachings disclosed herein.

FIG. 2 illustrates the example heatmap of FIG. 1 and a second heatmap following the adjustment of workloads across the servers in accordance with teachings disclosed herein.

FIG. 3 illustrates an example thermal camera used to monitor temperatures of the example server cluster of FIG. 1.

FIG. 4 is a schematic representation of an example task distribution system implemented in accordance with teachings disclosed herein.

FIG. 5 is a block diagram of an example implementation of the temperature-based workload distribution circuitry of FIG. 4.

FIG. 6 is a flowchart representative of example machine readable instructions and/or example operations that may be executed, instantiated, and/or performed by example programmable circuitry to implement the temperature-based workload distribution circuitry of FIG. 5.

FIG. 7 is a schematic representation of another example server farm (e.g., data center) that includes an example cluster of servers implemented in accordance with teachings disclosed herein.

FIG. 8 shows a temperature graph, a server workload graph, and a global workload graph representing the results of a simulation of server clusters complying with the example decentralized temperature-based load balancing model disclosed herein.

FIG. 9 illustrates a modified version of the example server farm of FIG. 7

FIG. 10 is a block diagram of an example implementation of the temperature-based workload distribution circuitry of FIGS. 7 and/or 9.

FIGS. 11A and 11B are flowcharts representative of example machine readable instructions and/or example operations that may be executed, instantiated, and/or performed by example programmable circuitry to implement the temperature-based workload distribution circuitry of FIG. 10.

FIG. 12 is a block diagram of an example processing platform including programmable circuitry structured to execute, instantiate, and/or perform the example machine readable instructions and/or perform the example operations of FIG. 6 to implement the temperature-based workload distribution circuitry of FIG. 5.

FIG. 13 is a block diagram of an example processing platform including programmable circuitry structured to execute, instantiate, and/or perform the example machine readable instructions and/or perform the example operations of FIGS. 11A and 11B to implement the temperature-based workload distribution circuitry of FIG. 10.

FIG. 14 is a block diagram of an example implementation of the programmable circuitry of FIGS. 12 and/or 13.

FIG. 15 is a block diagram of another example implementation of the programmable circuitry of FIGS. 12 and/or 13.

FIG. 16 is a block diagram of an example software/firmware/instructions distribution platform (e.g., one or more servers) to distribute software, instructions, and/or firmware (e.g., corresponding to the example machine readable instructions of FIGS. 6, 11A, and/or 11B) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Server farms (e.g., data centers) often include vast arrays of servers, usually located in specially designed racks in large buildings or warehouses. Server farms provide cloud services for multiple clients all over the world. The seamless and quick operation they provide can sometimes obscure the complex data transmission and task distribution protocols necessary to allow all these separate, interconnected server units to provide processed services like they were a single unit. Task distribution algorithms are sophisticated and respond to different prioritization rules, in which a certain task requirement is assigned to the unit (or units) with better availability, closer connection, first response, etc.

Server efficiency, which may reflect the amount of energy a server consumes per unit of data processing, is a variable that server farm managers follow very closely, given the cost associated with high-performance processing. High temperatures and poor thermal management in server racks heavily reduce server efficiency. High temperatures also reduce a server's lifespan and can result in high noise levels (from the fans required to dissipate the heat). Newer designs for processors (e.g., central process units (CPUs), graphics processor units (GPUs), Field Programmable Gate Arrays (FPGAs), etc.) are expected to increase their power consumption, and heat dissipation requirements. As a result, thermal management in server farms is expected to become an increasingly important issue.

To meet the demands of effective thermal management, server farms often implement high-performance air conditioning systems to deal with the heat the servers and/or other systems produce while in operation. In addition to air conditioning systems that cool the ambient room temperature in an area containing servers, each server may individually implement measures that provide some level of temperature control (e.g., adjusting a local fan speed, throttling an associated processor, shutting down prior to overheating, etc.) in response to local temperature sensors (e.g., thermistors). That is, existing approaches to thermal management include trying to cool all servers in an enclosed area (e.g., a warehouse) collectively (e.g., via an air conditioning system) and/or trying to control the temperature of each server individually (e.g., via controlling features internal to a server housing). However, known thermal management solutions do not account for thermal interactions between neighboring servers or their specific locations within racks and/or an associated temperature-controlled enclosure where the servers are located.

Examples disclosed herein improve upon existing thermal management systems by taking into account the unique circumstances of each server in a server farm as a result of its spatial relationship to other servers and its special relationship to other features in the surrounding environment. For instance, servers closer to and/or directly aligned with air conditioning vents are likely to be cooler than servers spaced farther away. Further, servers higher in a rack are likely to be warmer than servers lower in the rack because the heat from the lower servers rises towards the higher servers. Further still, heat generated by one server (and/or other electronic devices) may affect the temperature of adjacent (e.g., above, below, or laterally to the side) servers (and/or other electronic devices) with larger effects resulting from servers (and/or other electronic devices) in closer proximity than from servers (and/or other electronic devices) spaced farther away (e.g., spaced farther apart within the same server rack, located in two separate racks, located in separate rows or aisles of racks, etc.). Furthermore, the relative position of the adjacent servers (and/or other electronic devices) can play a role in the thermal interactions between them (e.g., heat from a first server is likely to have a greater effect on a server above rather than a server below the first server because heat rises as noted above).

In some examples, the unique circumstance of each server (and/or other electronic device) is directly monitored by collecting and aggregating temperature data from each server (and/or other electronic device) on a substantially real-time basis and mapping such temperatures to the physical location of each server (and/or other electronic device). In some examples, this spatial-temperature information is used to distribute compute tasks and/or workloads to servers with cooler temperatures to maintain a relatively uniform temperature distribution across all servers (and/or other electronic devices). That is, in some examples, temperature data for the servers (and/or other electronic devices) is used to adjust the workloads of the servers to reduce a difference in temperature between different ones of the servers (and/or other electronic devices). In some examples, the temperature data is collected from the temperature sensors (e.g., thermistors) already included within servers (and/or other electronic devices). Additionally or alternatively, in some examples, the temperature data is obtained using one or more thermal cameras that capture thermographic images of the servers (and/or other electronic devices). Examples disclosed herein are primarily described with references to servers in a server cluster (e.g., in a server farm). However, teachings disclosed herein can apply to any other suitable type of electronic devices that are communicatively connected and capable of taking on and/or offloading tasks that can affect the temperature of such devices.

The foregoing approaches rely on a central task distribution controller (e.g., which may be implemented by one or more of the servers in the server farm and/or other electronic device) to collect and analyze the temperature data and determine a suitable distribution of workloads based on such data. In other examples disclosed herein, a decentralized (e.g., distributed) load balancing system can be implemented to achieve a similar result without the need for a central controller or coordinator. Specifically, in some examples, each server implements a procedure to dynamically adjust the workload executed by different servers in a connected server cluster by each server sharing information about its own current (e.g., substantially real-time) temperature. Based on this information, each server can individually determine whether it is operating at a higher or lower temperature than the other servers that shared their temperatures. From this, each server can determine to either seek to offload some of its workload to other servers and/or to accept workloads offloaded from other servers. Specifically, in some examples, cooler servers advertise their ability to take on more workloads and/or accept request(s) to take on more workloads from other servers. At the same time, warmer servers offload some of their workload and/or decline to take on additional workloads. As multiple (e.g., all) connected servers (e.g., a server cluster, a rack of servers, multiple racks of servers, an entire warehouse of servers) implement the same procedure the servers will eventually converge towards a substantially uniform temperature distribution across the servers. Inasmuch as this convergence is achieved without a centralized controller or load balancing coordinator, this approach is scalable to any number of servers. Furthermore, regardless of whether a substantially uniform temperature distribution is achieved in a centralized manner or in a distributed manner, the result enhances overall efficiency, extends server lifespan, and reduces cooling costs without the need for additional expensive hardware.

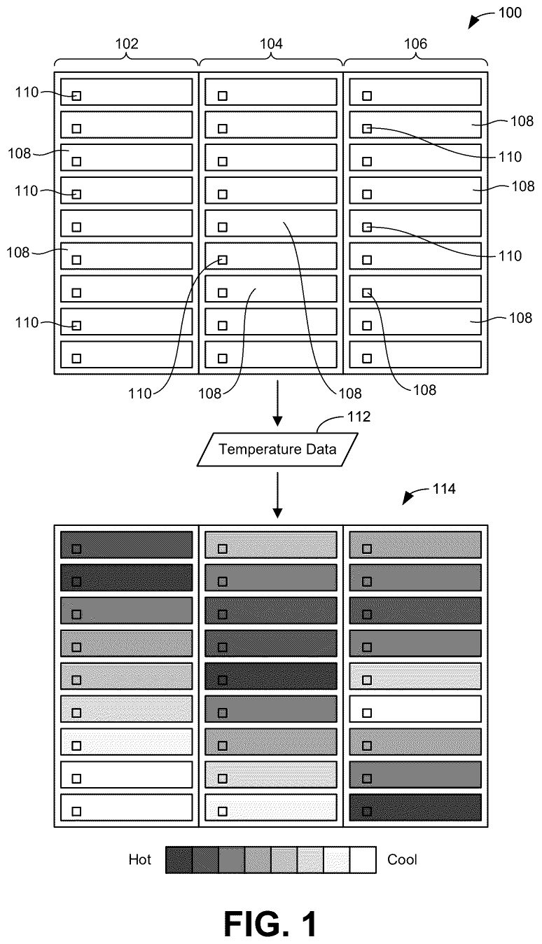

FIG. 1 is a schematic representation of an example server cluster 100 in a server farm that implements teachings disclosed herein. In this example, the server cluster 100 includes three separate server racks 102, 104, 106 each housing nine servers 108. Examples disclosed herein are not limited to the particular arrangement of servers 108 shown in the illustrated example. Rather, the example server cluster 100 can include any suitable number of racks 102, 104, 106 containing any suitable number of servers 108 (and/or other electronic devices). In some examples, one or more of the servers 108 are not included within a rack. In some examples, the racks 102, 104, 106 are omitted. Further, examples disclosed herein are limited to servers but instead encompass any sort of electronic device(s) in any combination (e.g., a mixture of servers and power supply units, etc.). However, for purposes of explanation, examples disclosed herein are described in terms of servers 108 in a server cluster 100.

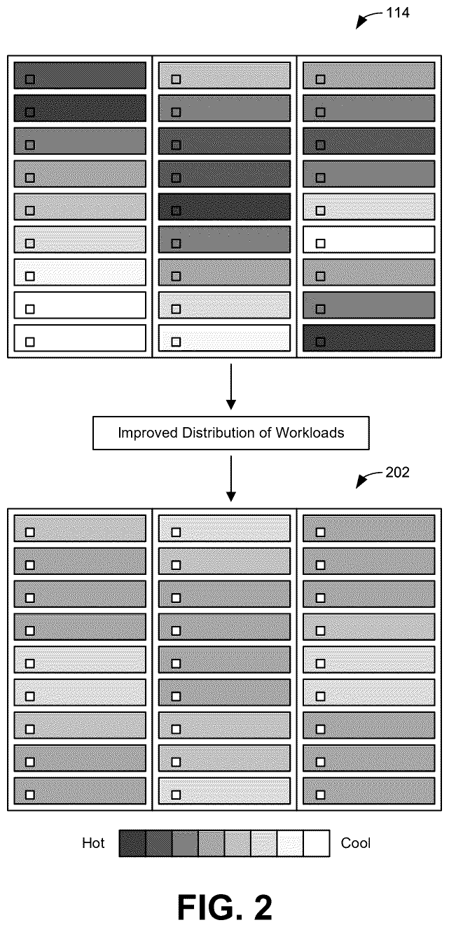

As represented in FIG. 1, each server includes a temperature sensor 110 (e.g., a thermistor) to measure a temperature of the corresponding server 108. In some examples, one or more of the servers include multiple temperature sensors 110. Temperature sensors 110, such as those represented in FIG. 1, are employed in known servers. In the past, such sensors 110 have been placed at strategic locations within the chassis of each server 108 to provide input to a corresponding fan control system that sets the airflow in certain areas of the associated server 108 depending on the reported temperature.

Whereas past uses of the temperatures sensors 110 are primarily limited as an input to a local (e.g., server-specific) cooling system (e.g., fan control system), examples disclosed herein use the temperatures reported from the different sensors 110 across the server cluster 100 (referred to herein as temperature data 112) in the aggregate to generate or define an indication of a temperature distribution across the server cluster 100. In this example, the temperature distribution is represented by a heatmap 114. As shown in FIG. 1, the heatmap 114 represents the temperature distribution of the servers 108 in the server cluster 100 based on the physical position of each server 108 in the cluster. In the illustrated example of FIG. 1, the heatmap 114 represents a possible temperature distribution prior to tasks and/or workloads being redistributed using the temperature data 112 as an input. As shown, some servers 108 are relatively hot while others are relatively cool. As a result, without some corrective action, the hot servers are likely to fail sooner than if the workloads were distributed in a way that resulted in a more uniform temperature distribution across all servers 108. Examples disclosed herein use the temperature data to determine a better distribution of workloads across the servers 108 for a more uniform temperature distribution as represented in the illustrated example of FIG. 2. Specifically, FIG. 2 illustrates the heatmap 114 of FIG. 1 (e.g., a first heatmap prior to adjusting workloads) and a second heatmap 202 following the adjustment of workloads across the servers 108.

Significantly, the temperature distribution across the servers 108 is not necessarily the same as the workload distribution across the servers. As mentioned above, the thermal interactions between the servers 108 (and/or other electronic devices) and with the surrounding environment is different for each server 108 because each server is in a different location relative to every other server 108 and, as a result, will heat up or remain cool to a different extent depending on the temperature of the surrounding servers 108, other structures and/or devices, and the ambient air conditions (e.g., as controlled by an air conditioning system). It is for this reason that the substantially uniform temperature distribution shown in the second heatmap 202 of FIG. 2 is unlikely to be achieved simply by assigning every server the same workload. Rather, the unique circumstances of each server 108 and its thermal interactions with its surrounding environment needs to be taken into account. In other words, due to the unique circumstance of each server 108, some of the servers may consistently overheat and/or operate at elevated temperatures relative to other servers, thereby making such servers more vulnerable over time. Monitoring the temperature of each server 108 in substantially real-time as workloads are distributed can serve as an indicator of the unique thermal interactions experienced by each server 108. Thus, using the temperature date 112 as an input, different workloads can be assigned to each server to achieve the uniform temperature distribution as represented in the second heatmap 202 of FIG. 2. In this manner, the useful life of each server 108 can be extended as long as possible. Furthermore, by controlling the server cluster 100 to operate with a relatively uniform temperature distribution, cooling systems no longer need to work as hard to prevent relative hot servers (as represented in the first heatmap 114) from overheating, thereby reducing power consumption and improving efficiency of the overall system.

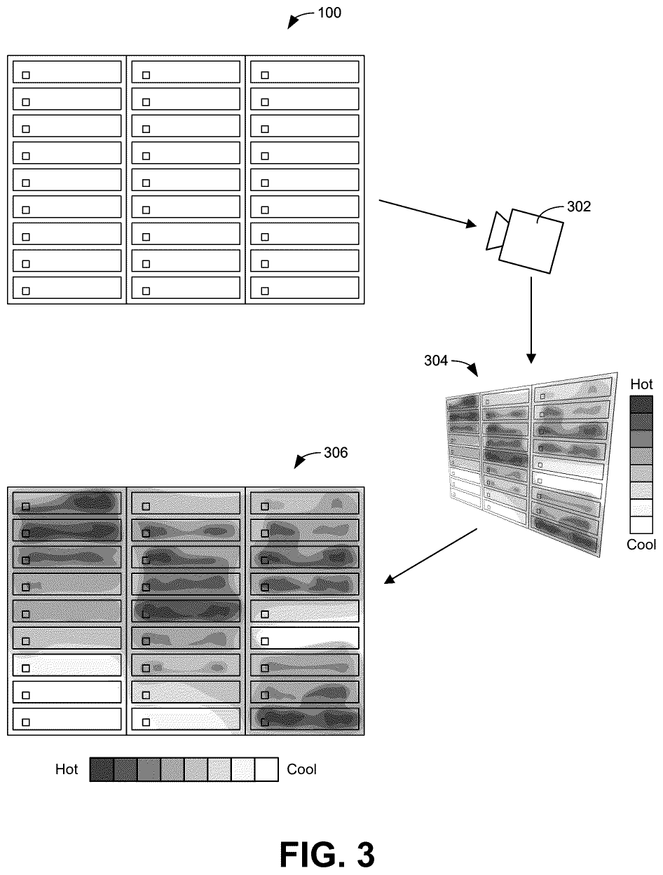

In the heatmaps 114, 202 illustrated in FIGS. 1 and 2, the temperature of each server 108 is represented by a single shade or color. In examples where a server includes more than one temperature sensor 110, the temperature of the server 108 used in the heatmap 114, 202 can be based on an average temperature measured for each server 108. In other examples, different temperatures from different temperature sensors 110 can be represented in the heatmaps 114, 202 for a more granular view of the temperature distribution across the server cluster 100. Additionally or alternatively, in some examples, temperature data indicative of the temperature distribution across the server cluster 100 can be obtained using one or more external thermal sensors (e.g., thermographic cameras, infrared cameras, etc.) as represented in FIG. 3.

In the illustrated example of FIG. 3, a thermal camera 302 is oriented towards the server cluster 100 to capture a thermographic image 304. In this example, due to the position of the camera 302 and the resulting angle and/or perspective of the camera 302, the server cluster 100 in the thermographic image 304 may appear skewed or distorted. Accordingly, in some examples, the thermographic image 304 may be rectified to produce a final heatmap 306 of the server cluster 100 with the temperature of each server 108 represented in the context of where it is physically located within the cluster. As shown in the illustrated example, the heatmap 306 is based on the thermographic image 304 and, thus, can provide a more accurate representation of the true temperature distribution across the server cluster 100 than may be possible using only the temperature sensors 110. As a result, using the heatmap 306 of FIG. 3 can provide for more reliable temperature data to be used to determine how to distribute workloads across the different servers 108 to arrive at a uniform temperature distribution like what is shown in FIG. 2.

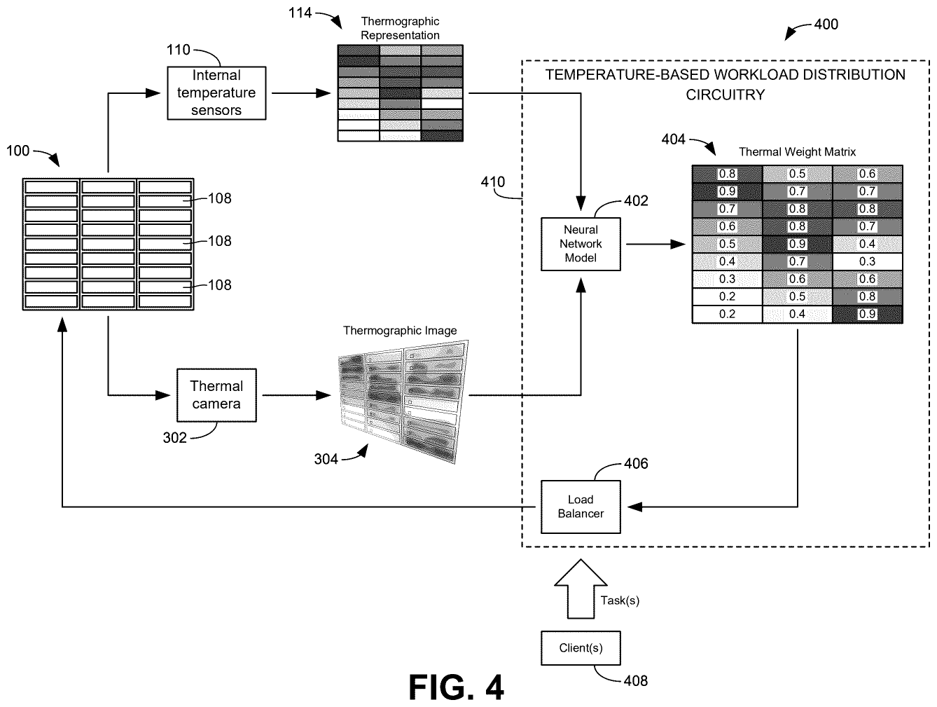

FIG. 4 is a schematic representation of an example task distribution system 400 implemented in accordance with teachings disclosed herein. The example task distribution system 400 is represented in the context of controlling the workload distribution of the servers 108 of the server cluster 100 of FIG. 1. In this example, the task distribution system 400 relies on the temperature sensors 110 contained internally within each of the servers 108 and an external thermal camera 302. In some examples, only the temperature sensors 110 are used and the thermal camera 302 is omitted. In other examples, the thermal camera 302 is used without reliance on temperature data from the internal temperature sensors 110. As discussed above in connection with FIG. 1, the temperature data from the temperature sensors 110 can be used to generate a heatmap 114 (e.g., a thermographic representation of the temperature distribution across the server cluster 100). Similarly, the thermal camera 302 can capture a thermographic image 304 (also referred to generically herein as temperature data) that represents the temperature distribution across the server cluster 100.

As shown in the illustrated example of FIG. 4, the temperature data from the temperature sensors 110 (e.g., the heatmap 114) and/or the temperature data from the thermal camera 302 (e.g., the thermographic image 304) are provided as inputs to a neural network model 402. In some examples, the thermographic image 304 may be rectified before being input to the neural network model 402. In other examples, the neural network model 402 is trained to receive the distorted thermographic image 304 as directly captured by the thermal camera 302. In some examples, multiple thermographic images 304 from multiple thermal cameras 302 can be provided as inputs to the neural network model 402. In some such examples, the different thermographic images 304 overlap one another such that the different images include at least some of the same servers 108. In other examples, the different thermographic images 304 capture different servers 108 in an overall server cluster 100.

In some examples, the neural network model 402 analyzes the temperature data to output a thermal weight matrix 404 containing different weighted values assigned to different servers 108 in the server cluster 100. The weighted values are determined by the neural network model 402 based on the temperature data provided as inputs to the model 402. In some examples, the weighted values directly correspond to the temperatures of the server 108. That is, in some examples, the heatmap 114 generated from the temperature sensors 110 can be used to directly generate the thermal weight matrix 404 without passing through the neural network model 402. In other examples, the neural network model 402 uses the measured temperature of each server 108 (either using the temperature sensors 110 or the thermal camera 302) in conjunction with the physical relationship of each server 108 relative to other servers and/or the surrounding environment to determine the weighted values in the thermal weight matrix. That is, in some examples, the weighted values take into account the thermal interactions between the servers 108 and the surrounding environment and/or between the servers themselves. In this example, the weighted values are normalized to range from 0 to 1. In other examples, the weighted values can have any suitable range (e.g., correspond to actual temperature values).

As represented in the illustrated example of FIG. 4, the thermal weight matrix 404 is provided to a load balancer 406 to balance and/or distribute workloads across the servers 108 in the server cluster 100. In some examples, the load balancer 406 can reassign and/or redistribute existing (e.g., ongoing) tasks and/or workloads between the servers 108. Additionally or alternatively, in some examples, the load balancer 406 assigns and/or distributes new tasks and/or workloads (e.g., incoming tasks from client(s) 408) based on the thermal weight matrix 404. More particularly, in some examples, the load balancer 406 identifies the servers 108 associated with the lowest weight values (e.g., corresponding to the coolest servers 108) for new tasks. As a result, these servers 108 will heat up without overburdening the other servers that are already operating at a higher temperature. In some examples, the foregoing process is repeated on an ongoing (e.g., substantially real-time, or nearly real-time) basis. That is, in some examples, fresh temperature data is captured and provided by the temperature sensors 110 at suitable intervals (e.g., less than every second, every second, every 2 seconds, every 3 seconds, every 5 seconds, every 10 seconds, every 15 seconds, every 30 seconds, etc.) to enable the thermal weight matrix 404 to be updated on an ongoing basis. Eventually, the load balancer will have distributed workloads across all servers 108 such that the operating temperature of any given server 108 is relatively similar to every other server 108. That is, the temperature distribution across the server cluster 100 will be substantially uniform as represented in the second heatmap 202 of FIG. 2.

In some examples, the neural network model 402 is based on a deep neural network and/or a convolutional neural network. In some examples, the neural network model is a convolutional transformer model (CTM). Training data can be provided by substantially real-time thermal measurements of the servers 108 (e.g., collected by temperature sensors 110) and by defining a target thermal weight value for the temperature scales. In some examples, as represented in FIG. 4, the neural network model 402 and the load balancer 406 are implemented by example temperature-based workload distribution circuitry 410 (sometimes referred to herein simply as workload balancing circuitry, for short). In some examples, one or more of the servers 108 in the server cluster 100 implement the example workload distribution circuitry 410. In some examples, one or more servers that are distinct and separate from the server cluster 100 implement the example workload distribution circuitry 410.

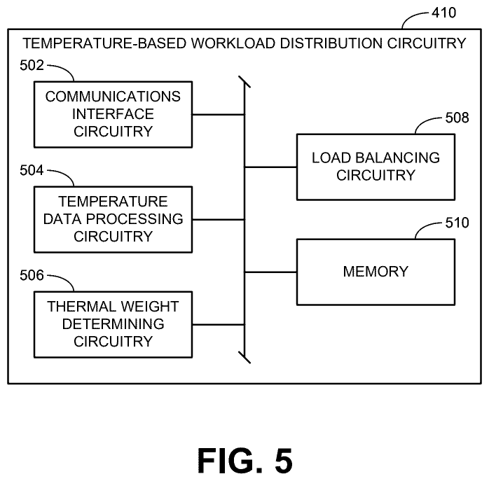

FIG. 5 is a block diagram of an example implementation of the workload distribution circuitry 410 of the example task distribution system 400 of FIG. 4. The workload distribution circuitry 410 of FIG. 5 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the workload distribution circuitry 410 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

As shown in the illustrated example of FIG. 5, the workload distribution circuitry 410 includes example communications interface circuitry 502, example temperature data processing circuitry 504, example thermal weight determining circuitry 506, example load balancing circuitry 508, and example memory 510.

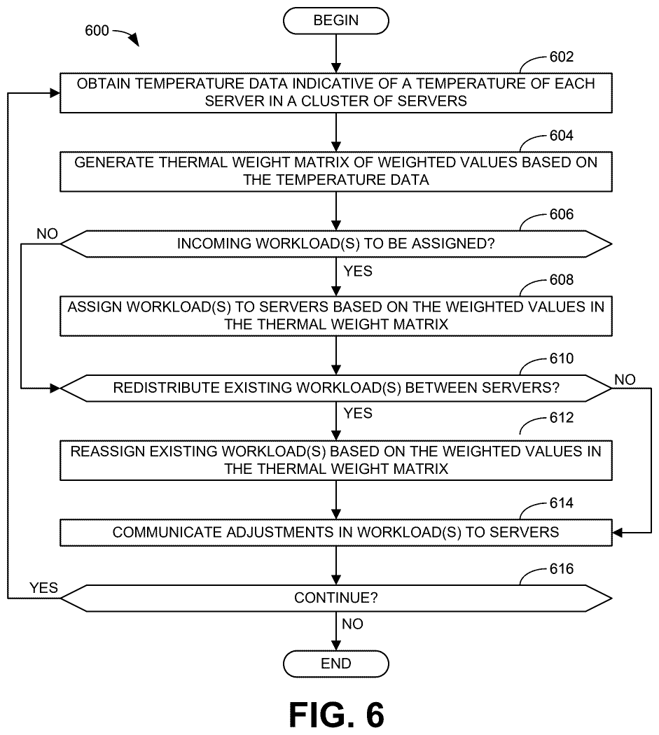

The example workload distribution circuitry 410 is provided with the example communications interface circuitry 502 to communicate with the servers 108 in the server cluster 100, the temperature sensors 110 included in such servers 108, and/or the thermal camera(s) 302. More particularly, in some examples, the communications interface circuitry 502 receives the temperature values measured by the temperature sensors 110. In some examples, the communications interface circuitry 502 may request (e.g., poll) the temperatures sensors 110 (and/or the corresponding servers 108) to provide these measured values on any suitable periodic basis. In other examples, the temperatures sensors 110 (and/or the corresponding servers 108) may automatically provide the measured values on a periodic basis. Similarly, in some examples, the communications interface circuitry 502 receives thermographic images 304 from the thermal camera(s) 302. In some examples, the communications interface circuitry 502 may send instructions that control operation of the thermal camera(s) 302. In other examples, the communications interface circuitry 502 passively receives thermographic images 304 provided by the camera(s) 302. Further, in some examples, the communications interface circuitry 502 transmits instructions to the different servers 108 in the server cluster 100 associated with the assignment and/or distribution of workloads to be executed by the servers 108. In some examples, the temperature data received by the communications interface circuitry 502 is stored in the example memory 510. In some examples, the communications interface circuitry 502 is instantiated by programmable circuitry executing communications interface instructions and/or configured to perform operations such as those represented by the flowchart(s) of FIG. 6

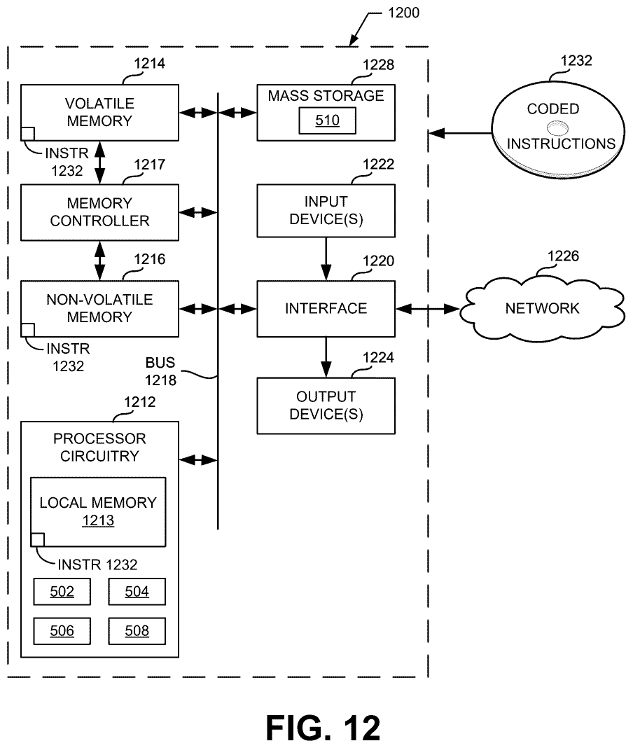

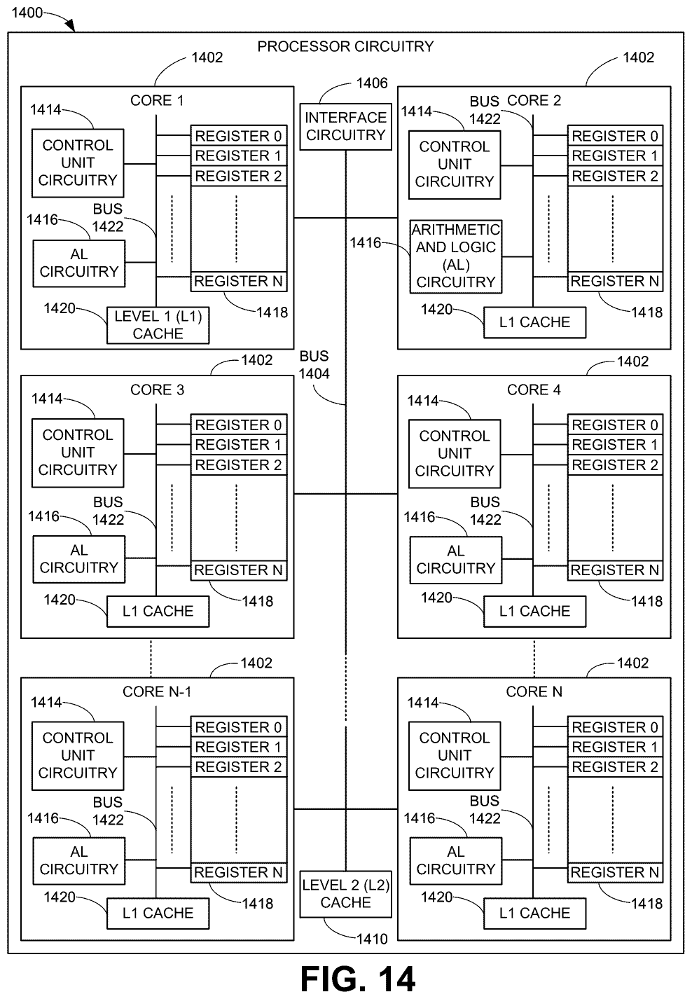

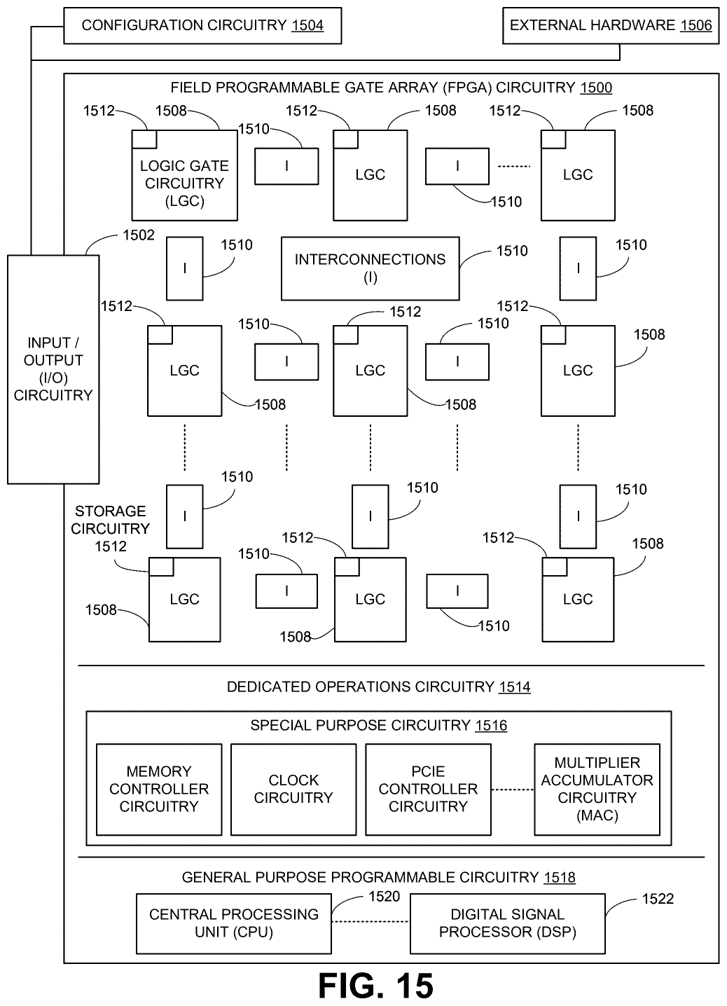

In some examples, the workload distribution circuitry 410 includes means for communicating. For example, the means for communicating may be implemented by communications interface circuitry 502. In some examples, the communications interface circuitry 502 may be instantiated by programmable circuitry such as the example programmable circuitry 1212 of FIG. 12. For instance, the communications interface circuitry 502 may be instantiated by the example microprocessor 1400 of FIG. 14 executing machine executable instructions such as those implemented by at least blocks 602, 614 of FIG. 6. In some examples, the communications interface circuitry 502 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the communications interface circuitry 502 may be instantiated by any other combination of hardware, software, and/or firmware. For example, the communications interface circuitry 502 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example workload distribution circuitry 410 is provided with the example temperature data processing circuitry 504 to perform initial processing on the temperature data from the temperature sensors 110 and/or the thermal camera(s) 302. For instance, in some examples, the temperature data processing circuitry 504 aggregates the temperature values measured by the temperature sensors 110 in the different servers 108 in the server cluster 100 and combines the measured values into a single data structure such as the example heatmap 114 of FIG. 4. In some examples, the temperature data processing circuitry 504 crops thermographic images 304 from the thermal camera(s) 302 so as to isolate the portion(s) of the images 304 associated with the server cluster 100. Additionally or alternatively, in some examples, the temperature data processing circuitry 504 geometrically transforms the thermographic images 304 to correct for distortion and/or skew arising from the perspective of the cameras 302 (e.g., generates rectified images similar to the heatmap 306 shown in FIG. 3). In some examples, the results of the processing of the temperature data by the temperature data processing circuitry 504 is stored in the example memory 510. In some examples, the temperature data processing circuitry 504 is instantiated by programmable circuitry executing temperature data processing instructions and/or configured to perform operations such as those represented by the flowchart(s) of FIG. 6. In some examples, the temperature data processing circuitry 504 is omitted.

In some examples, the workload distribution circuitry 410 includes means for processing temperature data. For example, the means for processing temperature data may be implemented by temperature data processing circuitry 504. In some examples, the temperature data processing circuitry 504 may be instantiated by programmable circuitry such as the example programmable circuitry 1212 of FIG. 12. For instance, the temperature data processing circuitry 504 may be instantiated by the example microprocessor 1400 of FIG. 14 executing machine executable instructions such as those implemented by at least blocks 602 of FIG. 6. In some examples, the temperature data processing circuitry 504 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the temperature data processing circuitry 504 may be instantiated by any other combination of hardware, software, and/or firmware. For example, the temperature data processing circuitry 504 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example workload distribution circuitry 410 is provided with the example thermal weight determining circuitry 506 to determine and/or generate weighted values for the different servers 108 in the server cluster 100 based on the temperature data. In some examples, the weighted values are represented in a thermal weight matrix 404 that may be stored in the example memory 510. In some examples, the thermal weight matrix 404 includes rows and columns of the weighted values arranged according to the rows and columns of the physical placement of the corresponding servers 108 in the server cluster 100. In some examples, the thermal weight determining circuitry 506 executes a neural network model 402 to generate the thermal weight matrix 404. In some examples, the model 402 is stored in the example memory 510. In some examples, the thermal weight determining circuitry 506 is instantiated by programmable circuitry executing thermal weight determiner instructions and/or configured to perform operations such as those represented by the flowchart(s) of FIG. 6.

In some examples, the workload distribution circuitry 410 includes means for determining weighted values based on temperature data. For example, the means for determining may be implemented by thermal weight determining circuitry 506. In some examples, the thermal weight determining circuitry 506 may be instantiated by programmable circuitry such as the example programmable circuitry 1212 of FIG. 12. For instance, the thermal weight determining circuitry 506 may be instantiated by the example microprocessor 1400 of FIG. 14 executing machine executable instructions such as those implemented by at least blocks 604 of FIG. 6. In some examples, the thermal weight determining circuitry 506 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the thermal weight determining circuitry 506 may be instantiated by any other combination of hardware, software, and/or firmware. For example, the thermal weight determining circuitry 506 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example workload distribution circuitry 410 is provided with the example load balancing circuitry 508 to determine a distribution or assignment of workloads and/or tasks to be executed by each of the servers 108 based on the weighted values in the thermal weight matrix 404. More particularly, in some examples, the load balancing circuitry 508 identifies the servers 108 associated with the lowest weighted values (e.g., associated with lower temperatures) to take on new workloads and/or to takeover workloads currently being executed by servers 108 with higher weighted values (e.g., associated with higher temperatures). In some examples, the load balancing circuitry 508 operates in conjunction with the communications interface circuitry 502 to provide the assigned workloads to each intended server 108. In some examples, the load balancing circuitry 508 is instantiated by programmable circuitry executing load balancing instructions and/or configured to perform operations such as those represented by the flowchart(s) of FIG. 6.

In some examples, the workload distribution circuitry 410 includes means for assigning tasks and/or workloads to servers 108. For example, the means for assigning may be implemented by load balancing circuitry 508. In some examples, the load balancing circuitry 508 may be instantiated by programmable circuitry such as the example programmable circuitry 1212 of FIG. 12. For instance, the load balancing circuitry 508 may be instantiated by the example microprocessor 1400 of FIG. 14 executing machine executable instructions such as those implemented by at least blocks 606, 608, 610, 612 of FIG. 6. In some examples, the load balancing circuitry 508 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the load balancing circuitry 508 may be instantiated by any other combination of hardware, software, and/or firmware. For example, the load balancing circuitry 508 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the temperature-based workload distribution circuitry 410 of FIG. 4 is illustrated in FIG. 5, one or more of the elements, processes, and/or devices illustrated in FIG. 5 may be combined, divided, re-arranged, omitted, eliminated, and/or implemented in any other way. Further, the example communications interface circuitry 502, the example temperature data processing circuitry 504, the example thermal weight determining circuitry 506, the example load balancing circuitry 508, the example memory 510, and/or, more generally, the example temperature-based workload distribution circuitry 410 of FIG. 5, may be implemented by hardware alone or by hardware in combination with software and/or firmware. Thus, for example, any of the example communications interface circuitry 502, the example temperature data processing circuitry 504, the example thermal weight determining circuitry 506, the example load balancing circuitry 508, the example memory 510, and/or, more generally, the example temperature-based workload distribution circuitry 410, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example temperature-based workload distribution circuitry 410 of FIG. 5 may include one or more elements, processes, and/or devices in addition to, or instead of, those illustrated in FIG. 5, and/or may include more than one of any or all of the illustrated elements, processes and devices.

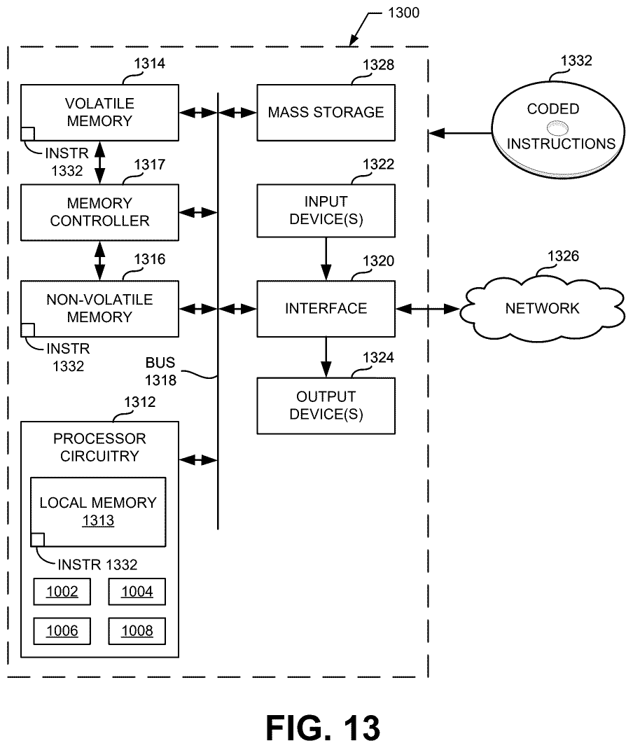

A flowchart representative of example machine readable instructions, which may be executed by programmable circuitry to implement and/or instantiate the temperature-based workload distribution circuitry 410 of FIG. 5 and/or representative of example operations which may be performed by programmable circuitry to implement and/or instantiate the temperature-based workload distribution circuitry 410 of FIG. 5, is shown in FIG. 6. The machine readable instructions may be one or more executable programs or portion(s) of one or more executable programs for execution by programmable circuitry such as the programmable circuitry 1212 shown in the example processor platform 1200 discussed below in connection with FIG. 12 and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The flowchart of FIG. 6 is representative of example machine readable instructions and/or example operations 600 that may be executed, instantiated, and/or performed by programmable circuitry to determine and control the distribution of workloads across multiple servers in a server cluster based on temperature data associated with the servers. The example machine-readable instructions and/or the example operations 600 of FIG. 6 begin at block 602, at which the example communications interface circuitry 502 obtains temperature data indicative of a temperature of each server 108 in a cluster of servers 100. In some examples, the temperature data corresponds to temperature values measured by temperature sensors 110 associated with the servers 108. In some examples, such temperature data is provided in the form of a heatmap 114. In other examples, the example temperature data processing circuitry 504 can aggregate and process the measured temperature values to generate such a heatmap 114. In some examples, the temperature data includes one or more thermographic images 304 of the servers 108 captured by one or more thermal cameras 302. In some examples, the temperature data includes both measured values from temperatures sensors 110 and thermographic image(s) 304 from thermal camera(s) 302.

At block 604, the example thermal weight determining circuitry 506 generates a thermal weight matrix 404 of weighted values based on the temperature data. In some examples, the thermal weight matrix 404 is also based on the spatial relationship of the servers 108 in the server cluster 100. In some examples, the thermal weight determining circuitry 506 generates the thermal weight matrix 404 by executing a neural network model 402 that uses the temperature data as inputs.

At block 606, the example load balancing circuitry 508 determines whether there are incoming workload(s) to be assigned. If so, control advances to block 608 where the example load balancing circuitry 508 assigns the workload(s) to the servers 108 based on the weighted values in the thermal weight matrix 404. Thereafter, control advances to block 610. Returning to block 606, if the example load balancing circuitry 508 determines that there are no incoming workload(s) to be assigned, control advances directly to block 610.

At block 610, the example load balancing circuitry 508 determines whether to redistribute existing workload(s) between the servers 108. If so, control advances to block 612 where the example load balancing circuitry 508 reassigns the existing workload(s) based on the weighted values in the thermal weight matrix 404. Thereafter, control advances to block 614. Returning to block 610, if the example load balancing circuitry 508 determines that the existing workload(s) are not to be redistributed, control advances directly to block 614.

At block 614, the example communications interface circuitry 502 communicates adjustments in workload(s) to the servers 108. Thereafter, control advances to block 616. If there are no adjustments in the workload(s) to be communicated, block 614 can be skipped. At block 616, the example workload distribution circuitry 410 determines whether to continue. If so, control returns to block 602 to obtain updated temperature data and repeat the process. Otherwise, the example program of FIG. 6 ends.

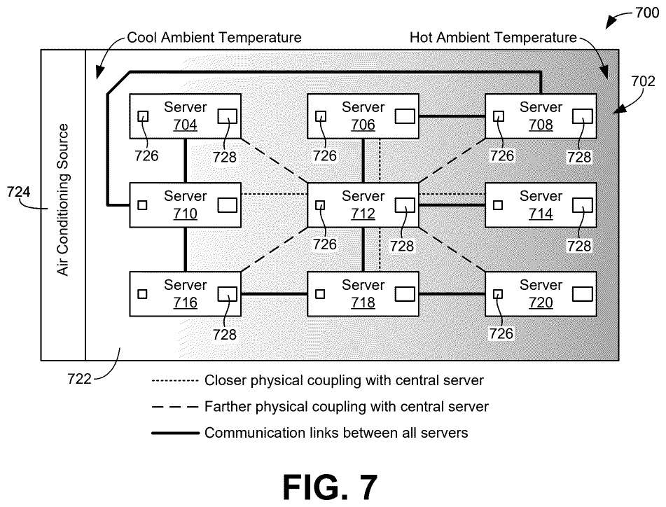

The example task distribution system 400 of FIG. 4 depends upon the implementation of the example workload distribution circuitry 410 as detailed in connection with FIG. 5 operating in accordance with the flowchart shown in FIG. 6. As noted above, in some examples, the workload distribution circuitry 410 may be implemented by one of the servers 108 in the server cluster 100. As a result, this can present a potential point of failure for the system. That is, if the particular server 108 implementing the workload distribution circuitry 410 fails, the entire task distribution system 400 fails. In some examples, more than one server 100 may be relied on to provide redundancy. However, this can be taxing on the system, particularly as the number of servers in the server cluster 100 increases. Thus, the example task distribution system 400 can be a challenge (or at least costly) to scale up to larger server clusters. Accordingly, in some examples, a distributed (e.g., decentralized) system may be implemented that takes into account server temperatures when distributing tasks without the need for a centralized controller or task manager as detailed below in connection with FIGS. 7-9.

FIG. 7 is a schematic representation of an example server farm 700 (e.g., data center) that includes a cluster 702 of servers 704, 706, 708, 710, 712, 714, 716, 718, 720 implemented in accordance with teachings disclosed herein. In this example, there are nine different servers 704-720 arranged in three rows of three. In other examples, any suitable number of servers 704-720 may be employed in any suitable arrangement. In some examples, some or all of the servers 704-720 are contained within racks similar to what was described above regarding the server cluster 100 of FIG. 1.

The particular spatial relationships between the different servers 704-720 and relative to the surrounding environment 722 (e.g., a room, an enclosure, a building, etc.) give rise to unique thermal interactions for each server. For purposes of illustration, in this example, the surrounding environment 722 includes an air conditioning source 724 positioned to one side (e.g., the left side in FIG. 7) of the server cluster 702. The location of the air conditioning source 724 results in a temperature gradient across the ambient air within the environment 722. As a result, as represented in the illustrated example, the ambient air temperature adjacent the first, fourth, and seventh servers 704, 710, 716 (closest to the air conditioning source 724) is cooler than the ambient air temperature adjacent the third, sixth, and ninth servers 708, 714, 720 (farthest from the air conditioning source 724). The different positions of the servers 704-720 relative to the surrounding environment 722 results in different thermal experience for each of the servers 704-720.

The thermal interactions experienced by each server 704-720 are further distinguished from one another by the spatial relationship between the different servers 704-720. For purposes of explanation, different spatial relationships of the fifth server 712 (e.g., the center server) are represented by different broken lines indicating different levels of thermal interaction. Specifically, the broken lines with short dashes represent the closest physical couplings between servers 704-720 associated with the greatest thermal interactions. In this case, the closest physical couplings included directly above, directly below, and directly to either lateral side. In some examples, servers directly above and below a given server may be considered closer than the servers laterally to the side for purposes of thermal interactions. In the illustrated example, the broken lines with the longer dashes represent the farther physical couplings between servers 704-720 associated with a lower thermal interaction. In this example, these farther physical couplings include couplings to servers that are diagonally adjacent to a given server (e.g., the fifth server 712). In some examples, lower levels of physical couplings between servers even farther apart may be considered for purposes of thermal interactions.

Due to the unique circumstance of each server 704-720 resulting from its placement within the cluster 702 relative to other servers 704-720 in the cluster and its placement relative to the surrounding environment 722, each server will operate at a different temperature to others even assuming all servers are executing the same workload. Thus, as discussed above, a uniform temperature distribution across all servers 704-720 in the cluster 702 cannot be achieved simply by assigning servers the same amount of workload(s). Examples disclosed herein take into account the unique circumstances of each server 704-720 when distributing workloads to achieve a more uniform temperature distribution. Similar to the example task distribution system 400 discussed above in connection with FIG. 4, temperature data from temperature sensors 726 in the servers 704-720 is used as a measure or indication of the unique circumstances of each server 704-720. In some examples, the temperature sensors 726 are the same or similar to the temperature sensors 110 discuss above in connection with FIGS. 1-6. Thus, the discussion of the temperatures sensors 110 provided above applies equally to the temperatures sensors 726 shown in FIG. 7. Among other things, although only one temperature sensor 726 is shown in each server 704-720, in some examples, one or more of the servers 704-720 includes multiple temperature sensors 726.

Unlike the example task distribution system 400 of FIG. 4 that includes a centralized controller (e.g., the workload distribution circuitry 410) to aggregate and analyze temperature data to determine the distribution of workloads, workloads are distributed across the server cluster 702 of FIG. 7 without a centralized controller. Instead, in the illustrated example of FIG. 7, a decentralized system is implemented that involves example temperature-based workload distribution circuitry 728 implemented by each of the servers 704-720. As discussed further below, the workload distribution circuitry 728 in each server 704-720 monitors the temperature of the corresponding server (referred to herein as the local temperature for each server) and shares such information with all other servers with which each given server is in direct communication. Thus, the workload distribution circuitry 728 in each server 704-720 will receive temperature data from one or more other servers that can then be compared locally by each server to determine whether the local server is operating at a higher or lower temperature than its connected neighbors. In some examples, if the temperature of a particular server is higher than its neighbors, the corresponding workload distribution circuitry 728 in the particular server identifies tasks and/or workloads currently being executed by the particular server to be proposed for offloading to a neighboring server. If, on the other hand, the temperature of the particular server is lower than its neighbors, the corresponding workload distribution circuitry 728 determines to accept one or more tasks and/or workloads proposed for offloading from a neighboring server. In this manner, warmer servers 704-720 will seek to pass off workloads while cooler servers 704-720 will accept such workloads until a consensus is achieved at which all servers are operating at approximately the same temperature. In addition to reaching a substantially uniform temperature distribution, the decentralized load balancing methodology disclosed herein also ensures that the global server workload (e.g., for the entire cluster 702) remains unaltered. That is, in some examples, no task is left unattended, and no task is repeated.

In the context of the decentralized load balancing methodology outlined above, neighboring servers are defined based on direct (e.g., peer-to-peer) communication links between two servers. For instance, in addition to representing the different levels of physical coupling for different levels of thermal interactions, the illustrated example of FIG. 7 also includes thick solid lines representing the communication coupling between the servers 704-720. More particularly, the thick solid lines represent direct communication coupling between the associated servers 704-720, which are referred to herein as communication neighbors. That is, in this example, the first server 704 is only directly connected to the fourth server 710. Therefore, the first server 704 has only one communication neighbor. By contrast, the fifth server 712 (e.g., the center server) is directly connected to each of the second, sixth, and eighth servers 706, 714, 718. As such, each of the second, sixth, and eighth servers 706, 714, 718 constitute communication neighbors to the fifth server 712. Although many of the direct communication links between the servers 704-720 are shown as corresponding to the physical couplings, this need not be the case. Rather, any given server 704-720 can be directly communicatively coupled to any other server. For instance, although the third and fourth servers 708, 710 are shown as being spaced apart, they are nevertheless directly communicatively coupled. As such, the third and fourth servers 708, 710 are communication neighbors. In other words, as used herein, “communication neighbors” may or may not be physical neighbors. In some examples, one or more servers 704-720 can be directly coupled to all other servers in the server cluster 702 (e.g., it is a communication neighbor to every other server in the cluster). However, it is not necessary for any server to be directly connected to every other server. That is, even if a given server 704-720 is not directly communicatively coupled to one or more other servers, the given server 704-720 may still be indirectly communicatively coupled to every other server by way of one or more intermediate servers. Thus, in this example, all servers 704-720 in the server cluster 702 are either directly or indirectly communicatively coupled. In situations where a server farm includes different sets of servers that are completely isolated from one another (e.g., there is neither direct nor indirect communication links), the different sets of servers can be implemented as distinct server clusters.

The example decentralized load balancing system is premised on the following temperature model used for each server and follows from standard temperature diffusion modelling:

$${\dot{T}}_{i} = - {c}_{A} ( {T}_{i} - {T}_{i}^{A} ) - {\sum }_{i = 1}^{N} {c}_{P}^{ij} ( {T}_{i} - {T}_{j} ) - {c}_{u} ϕ ( {u}_{i} ) \qquad Eq . 1$$

where i identifies the local server for which the model is being used, j identifies each of the communication neighbors (as defined above to include those servers with a direct communication link with the local server), Tᵢ, Tⱼ are the temperatures at servers i, j,

$${T}_{i}^{A}$$

is the ambient temperature at server i, uᵢ∈[0,1] is the current workload of the local server relative to a full workload capacity, and ϕ(⋅) is a function modeling the conversion between the current workload and the temperatures of the local and communication neighbor servers in the above model. The constants

$${c}_{A} , {c}_{P}^{ij} , {c}_{u} > 0$$

correspond to the thermal coupling of the temperature Tᵢ relative to ambient temperature, communication neighbors, and the local workload, as defined by the thermodynamic properties of the components involved and their particular physical arrangement. Moreover,

$${c}_{P}^{ij}$$

encodes the strength of thermal influence of server j over server i. Finally, \dot{T}ᵢ is the time derivative of Tᵢ. This model follows from basic thermo-dynamics considering the heat transfer between the local server and its communication neighbors, and the heat dissipation from the local server to the ambient surroundings.

If workloads uᵢ=uⱼ are equal for all servers (e.g., perfect workload balance), the dynamical model for temperatures will converge to different temperatures for different servers because of the unique circumstance of each server arising from the non-uniform ambient temperature and the different physical relationships between the different servers. Hence, examples disclosed herein provide an adaptive workload balancing mechanism based on consensus techniques that results in the output of the thermal system reaching consensus with a substantially uniform temperature distribution across the server cluster 702.

Specifically, to implement the decentralized load balancing system disclosed herein, time is divided into discrete instants of time k in which each server can change its workload balance. In some examples, the instant of time k can be any suitable duration of time (e.g., less than 1 second, 1 second, 2 seconds, 3 seconds 5 seconds, 10 seconds, 15 seconds, 30 seconds, etc.). Having established the time interval for each opportunity to rebalance workloads, the workload for the next (e.g., k+1) time period can be expressed as:

$${\hat{u}}_{i} [ k + 1 ] = {u}_{i} [ k ] + {v}_{i} [ k ] \qquad Eq . 2$$

where vᵢ[k] is a local workload adjustment variable representing the change or adjustment in workload at server i (e.g., the local server) in the time slot k. The local workload adjustment variable can be positive or negative depending on whether server i has excess workload relative to other servers (e.g., it is being overworked) causing its temperature to be higher than the communication neighbor servers or whether server i has excess capacity relative to other servers (e.g., it is being underworked) as indicated by its temperature being lower than the communication neighbor servers.

More particularly, the local workload adjustment variable can be defined as follows:

$${v}_{i} [ k ] = - g {\sum }_{j ∈ {N}_{i}} ( {T}_{i} - {T}_{j} ) \qquad Eq . 3$$

where Nᵢ is the index set corresponding to the number of communication neighbors of server i with which it is in direct communication. In Equation 3, g is a constant gain which can be increased to penalize the temperature disagreement between servers with more strength.

As outlined above, the local workload adjustment variable indicates an amount of change in workload of server i relative to all communication neighbors to server i. As discussed above, in some examples, server i can be in direct communication with more than one communication neighbor. Accordingly, in some examples, the local workload adjustment variable is divided by the number of communication neighbors to define a neighbor-specific workload adjustment variable:

$$\begin{matrix}{v}_{j} [ k ] = \frac{{v}_{i} [ k ]}{\vert {N}_{i} \vert} , & {\hat{u}}_{j} [ k + 1 ] = {u}_{j} [ k ] + {v}_{j} [ k ]\end{matrix} \qquad Eq . 4$$

where |Nᵢ| is the number of communication neighbors of server i.

In some examples, the local workload adjustment variable for server i (e.g., Equation 3) is computed by the workload distribution circuitry 728 implemented by server i based on the local temperature data for the local server (e.g., server i) and the temperature data provided by each of the communication neighbor servers (e.g., each server j). Further, in some examples the workload distribution circuitry 728 of the local server computes the neighbor-specific workload adjustment variable for server j (e.g., Equation 4) that is then communicated to each communication neighbor of the local server as a request to offload tasks in the amount corresponding to the neighbor-specific workload adjustment variable. In some examples, the neighbor-specific workload adjustment variable is calculated only when the local workload adjustment variable is negative indicating an excess workload that needs to be offloaded to reduce the temperature of the local server relative to its communication neighbors. That is, in some examples, if the local workload adjustment variable is positive, the local server is cooler than its communication neighbor servers such that it would not make sense to attempt to offload additional workload(s). Accordingly, in such scenarios, the neighbor-specific workload adjustment variable is not provided by the local server to the communication neighbors.

In some examples, the communication neighbor servers will accept the task(s) to be offloaded from the local server as indicated by the neighbor-specific workload adjustment variable (and/or the local server will accept task(s) to be offloaded from the communication neighbors) if ûᵢ[k+1], ûⱼ[k+1]∈[0,1]. That is, requests for offloading workload(s) from one server to another will be accepted, if all new workload assignments for both server i and its communication neighbors are feasible (e.g., the total workload assigned to any given server does not exceed its workload capacity). In that case, the new workloads (during the next time period) for each server are defined as follows:

$$\begin{matrix}{u}_{i} [ k + 1 ] = {\hat{u}}_{i} [ k + 1 ] , & {u}_{j} [ k + 1 ] =\end{matrix} {\hat{u}}_{j} [ k + 1 ] \qquad Eq . 5$$

If the feasibility condition is not fulfilled (e.g., a communication neighbor server rejects the request to take on tasks offloaded from the local server), the local server (e.g., server i) retains the associated workloads and waits for the next time slot to try again. Eventually, one server will be hot or cold enough such that the feasibility condition is fulfilled, and the workloads will be rebalanced. Such rebalancing will result in changes in temperatures of the servers that either offloaded or took on the excess workload, thereby resulting in the possibility for the feasibility condition to be fulfilled with respect to other servers for further rebalancing in subsequent time slots. Over time, this process will result in a convergence towards a substantially uniform temperature distribution across the server cluster 702 despite the fact that some servers may have higher workloads than others.

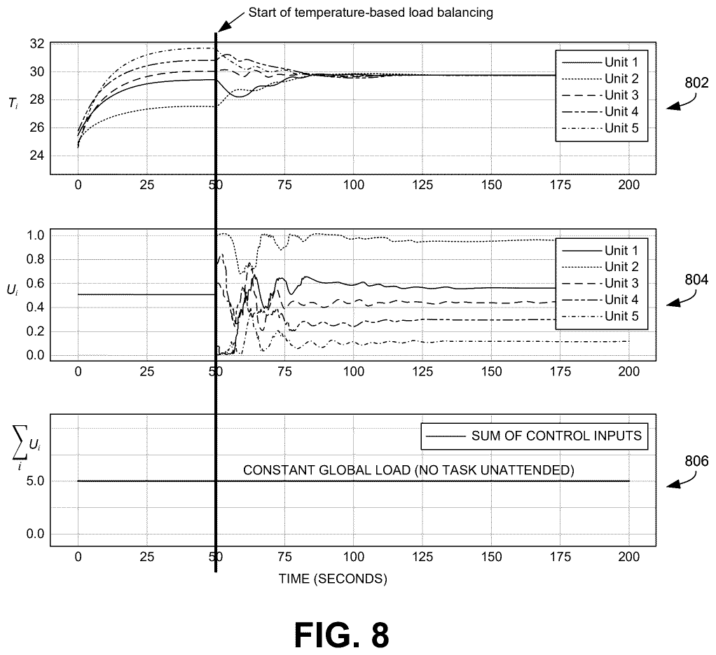

This is represented in the graphs shown in FIG. 8. Specifically, FIG. 8 shows a temperature graph 802, a server workload graph 804, and a global workload graph 806 representing the results of a simulation complying with the decentralized temperature-based load balancing model described above in a server cluster including five different servers. As indicated in the server workload graph 804, the first 50 seconds of the simulation involve a perfect workload balance across all servers with each server having a workload that is 50% of its full capacity. However, during this first 50 seconds, temperature is not taken into account. That is, the decentralized temperature-based load balancing model outlined above is not being applied during the first 50 seconds. As shown in the temperature graph 802, despite the identical workloads (e.g., 50% of capacity) being executed by each server, the resulting temperature differs between the servers. This difference in temperature is the result of different thermal interactions between the servers and the ambient environment based on the different positions of the servers relative to one another and the ambient environment.

After 50 seconds into the simulation, the temperature-based load balancing based on the example decentralized temperature-based load balancing model disclosed above is initiated. Once this is initiated, as shown in the temperature graph 802, the temperatures of the different servers begin to converge to a uniform temperature. Notably, as this occurs, the workloads of the different servers diverge to different amounts as shown in the server workload graph 804. In other words, the temperature consensus is made possible by uniquely adapting the workload of each server depending on its unique circumstances and resulting ability to dissipate heat to neighboring servers and ultimately to the ambient environment. The substantially uniform temperature across all servers helps to improve the reliability and longevity of all the servers. Significantly, this advantage is achieved without any change to the global workload as represented by the global workload graph 806. In other words, the uniform temperature distribution is achieved without any task going unattended.

As noted above, none of the servers need to be in communication with every other server. Rather, each server need only be in direct communication with one or more other servers (e.g., communication neighbors) for this decentralized methodology to work so long as all servers in a server cluster are at least indirectly connected. Each server makes its own decisions (using the associated workload distribution circuitry 728) using only cooperation with a subset of the rest of the servers (namely, its direct communication neighbors). As a result, this methodology is applicable to any suitable topology and scalable to any suitable size of server cluster. Further, there is no need for a central server to control and make decisions for the entire cluster, thereby providing a more robust solution with no single point of failure. That is, if a single server fails, the rest of the servers can dynamically adapt and converge towards a temperature consensus. Furthermore, the proposed solution is relatively lightweight and does not introduce significant additional computational load to the servers.

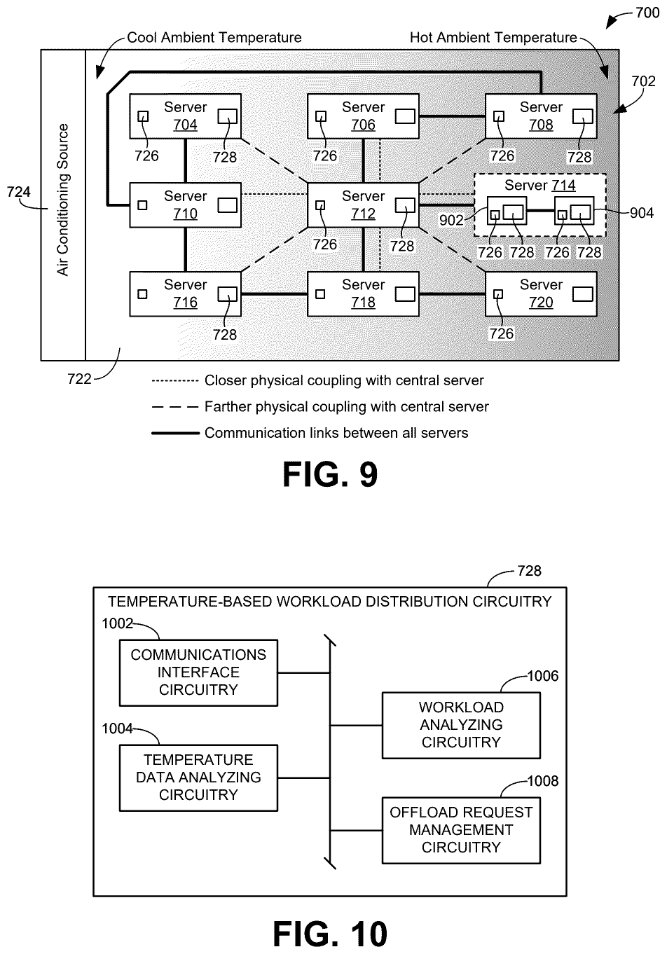

The workload adjustment variable defined in Equation 3 acts as a control action in the system. However, the particular mathematical expression can be defined in different ways to achieve a similar result. The general idea is to compare the measured temperature of the local server to the measured temperature of the communication neighbor servers and adjust workloads up or down depending on whether the local temperature is higher or lower than the temperatures of the communication neighbors. Further, other possible control actions are possible to implement other consensus control techniques in accordance with teachings disclosed herein to pursue different goals. For example, Distributed Model Predictive Control (DMPC) may be used to enforce the constant global workload condition, while implementing techniques disclosed herein to improve (e.g., optimize) both consensus and power consumption objectives that favor consensus and reduce (e.g., minimize) other features such as power consumption. Further, while the examples discussed herein are described in the context of server farms or data centers, the examples disclosed herein can be applied to any cluster of communicatively interconnected servers. Furthermore, teachings disclosed herein can be applied to individual components of a server as discussed below in connection with FIG. 9.

FIG. 9 illustrates a modified version of the example server farm 700 of FIG. 7. Specifically, FIG. 9 is identical to FIG. 7 except that the sixth server 714 has been expanded to schematically represent separate operating components 902, 904 within the server 714. As shown in the illustrated example, each of the operating components 902, 904 includes at least one associated temperature sensor 726. Further, each of the operating components 902, 904 implements and/or is associated with corresponding workload distribution circuitry 728. While the example server 714 is shown as including two operating components 902, 904, the server 714 may include any number of operating components. Further, in some examples, the operating components 902, 904, can correspond to any suitable types of components that produce heat when executing workloads and/or are capable of taking on more tasks and/or offloading tasks as appropriate. For instance, the operating components 902, 904 may be CPUs, GPUs, memory, etc.

As represented by the thick solid line between the two operating components 902, 904, the two components are directly communicatively coupled. Thus, in the context of this disclosure, the two components 902, 904 can function as communication neighbors. That is, in some examples, the operating components 902, 904 implement the decentralized temperature-based load balancing model outlined above to balance their workloads in a manner that achieves a substantially similar temperature distribution across the components 902, 904. In some examples, operating components within any of the other servers 704-720 in the server cluster 702 may similarly be implemented to achieve substantially uniform temperatures.

Additionally or alternatively, in some examples, the individual operating components 902, 904 of the sixth server 714 (and/or other servers) can be treated as individual nodes in the network of servers in the server cluster 702. That is, in some examples, the individual operating components 902, 904 are treated as communication neighbors with other servers (or operating components in such servers) to enable workload balancing across the server cluster 702 at the level of individual operating components. In such examples, the individual nodes in the network are not servers, but they can be treated in effectively the same way for purposes of implementing the decentralized temperature-based load balancing model disclosed herein.

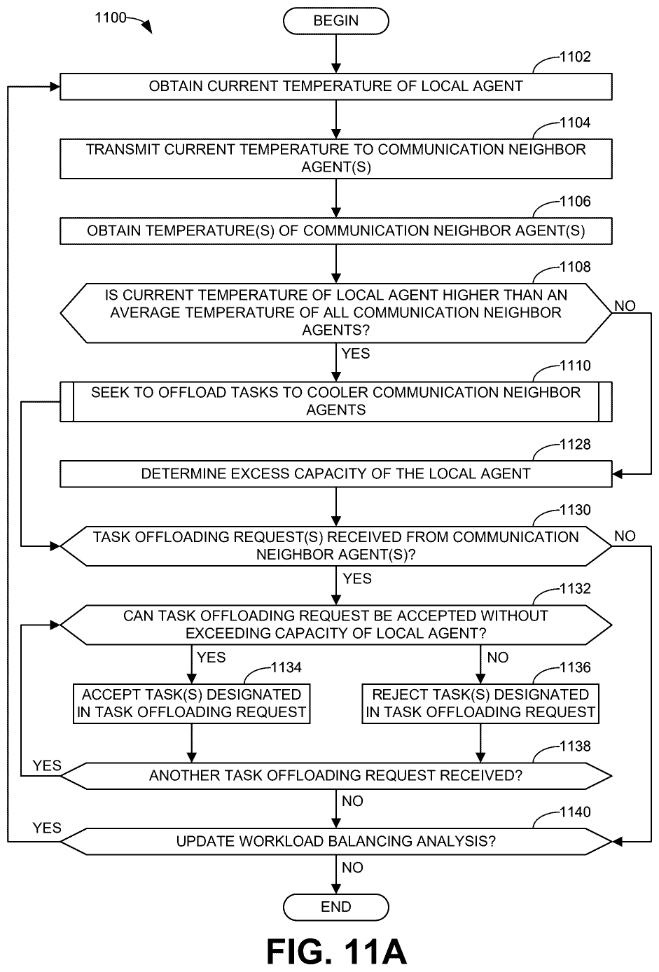

FIG. 10 is a block diagram of an example implementation of the workload distribution circuitry 728 of FIGS. 7 and/or 9 to balance the workloads of communicatively coupled servers (and/or operating components of such servers) in a manner that converges towards a substantially uniform temperature distribution across the servers (and/or associated operating components). The workload distribution circuitry 728 of FIG. 10 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the workload distribution circuitry 728 of FIG. 10 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 10 may, thus, be instantiated at the same or different times. Some or all of the circuitry of FIG. 10 may be instantiated, for example, in one or more threads executing concurrently on hardware and/or in series on hardware. Moreover, in some examples, some or all of the circuitry of FIG. 10 may be implemented by microprocessor circuitry executing instructions and/or FPGA circuitry performing operations to implement one or more virtual machines and/or containers.

As shown in the illustrated example of FIG. 10, the workload distribution circuitry 728 includes example communications interface circuitry 1002, example temperature data analyzing circuitry 1004, example workload analyzing circuitry 1006, and example offload request management circuitry 1008. In some examples, the workload distribution circuitry 728 includes some or all of the functionality of the example workload distribution circuitry 410 outlined above in connection with FIGS. 4 and 5.

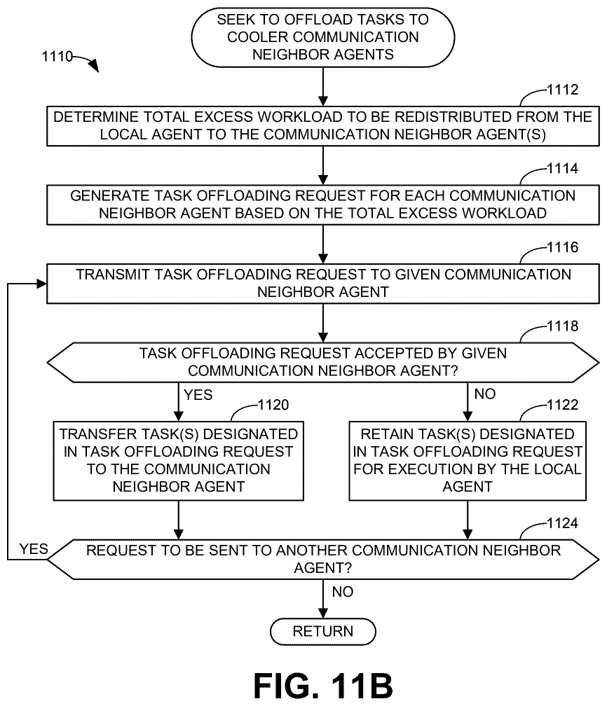

The example workload distribution circuitry 728 is provided with the example communications interface circuitry 1002 to communicate with the temperature sensors 110 that are local to the server (or associated operating component) where the workload distribution circuitry 728 is implemented. In this manner, the workload distribution circuitry 728 is able to determine the current temperature of the local server or the associated operating component. Additionally, in some examples, the example communications interface circuitry 1002 is provided to communicate with compute devices to which the local server or the associated operating component is directly coupled (e.g., communication neighbors). As used in this context, the term “compute device” is an umbrella term to include both servers 704-720 and the individual operating components 902, 904 within the servers 704-720 (as well as any other type of suitable electronic devices). Communications between compute devices through the example communications interface circuitry 1002 enables the neighboring compute devices to share temperature data and/or workload data with one another. As a result, each workload distribution circuitry 728 associated with each compute device can decide (without a centralized controller) what workloads are to be retained and executed by the local compute device, what workloads are to be offloaded to a communication neighbor compute device, and what workloads are to be accepted from a communication neighbor. In some examples, the communications interface circuitry 1002 is instantiated by programmable circuitry executing communications interface instructions and/or configured to perform operations such as those represented by the flowchart of FIGS. 11A and 11B.

In some examples, the workload distribution circuitry 728 includes means for communicating. For example, the means for communicating may be implemented by communications interface circuitry 1002. In some examples, the communications interface circuitry 1002 may be instantiated by programmable circuitry such as the example programmable circuitry 1312 of FIG. 13. For instance, the communications interface circuitry 1002 may be instantiated by the example microprocessor 1400 of FIG. 14 executing machine executable instructions such as those implemented by at least blocks 1102, 1104, 1106, 1130, 1134, 1136 of FIGS. 11A and 11B. In some examples, the communications interface circuitry 1002 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the communications interface circuitry 1002 may be instantiated by any other combination of hardware, software, and/or firmware. For example, the communications interface circuitry 1002 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example workload distribution circuitry 410 is provided with the example temperature data analyzing circuitry 1004 to process the measured temperature values obtained from local temperature sensor(s) 110 as well the temperature values provided by the communication neighbors (based on measurements from the temperature sensors 110 in such communication neighbors). In some examples, the temperature data analyzing circuitry 1004 compares the measured temperature of the local compute device relative to the reported temperature(s) of the communication neighbor compute devices to determine whether the local compute device is hotter or colder than the communication neighbors. In some examples, this is accomplished by comparing the local temperature to an average of all available temperatures (e.g., the local temperature and the temperature of the communication neighbors). In some examples, this is accomplished by comparing the local temperature to an average of all temperatures of the communication neighbors (e.g., excluding the local temperature). In some examples, this is accomplished by evaluating the summation of temperature differences set forth in Equation 3. In some examples, the temperature data analyzing circuitry 1004 is instantiated by programmable circuitry executing temperature data analyzing instructions and/or configured to perform operations such as those represented by the flowchart of FIGS. 11A and 11B.

In some examples, the workload distribution circuitry 728 includes means for analyzing and/or comparing temperatures. For example, the means for analyzing and/or comparing may be implemented by temperature data analyzing circuitry 1004. In some examples, the temperature data analyzing circuitry 1004 may be instantiated by programmable circuitry such as the example programmable circuitry 1312 of FIG. 13. For instance, the temperature data analyzing circuitry 1004 may be instantiated by the example microprocessor 1400 of FIG. 14 executing machine executable instructions such as those implemented by at least blocks 1102,1108,1112 of FIGS. 11A and 11B. In some examples, the temperature data analyzing circuitry 1004 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the temperature data analyzing circuitry 1004 may be instantiated by any other combination of hardware, software, and/or firmware. For example, the temperature data analyzing circuitry 1004 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example workload distribution circuitry 410 is provided with the example workload analyzing circuitry 1006 to determine whether a change in workload of the local compute device is suitable based on the analysis of the temperature data performed by the temperature data analyzing circuitry 1004. More particularly, in some examples, the workload analyzing circuitry 1006 determines whether the local compute device is in a position to receive additional tasks offloaded from communication neighbors (e.g., based on a lower than average temperature) or needs to offload tasks to communication neighbors (e.g., based on a higher than average temperature). In some examples, whether the local compute device has an above average temperature or a below average temperature depends on whether the summation term in Equation 3 is positive or negative. Specifically, the summation term being negative indicates the local compute device is cooler than average, whereas the summation term being positive indicates the local compute device is warmer than average. In some examples, the example workload analyzing circuitry 1006 completes the evaluation of Equation 3 to determine the local workload adjustment variable (vᵢ[k]). That is, in some examples, the workload analyzing circuitry 1006 multiplies the summation term by the negative of the constant gain g. In some examples, this calculation is performed by the temperature data analyzing circuitry 1004 instead of the example workload analyzing circuitry 1006.

As discussed above, the local workload adjustment variable is an indication of the amount of workload the local compute device seeks to offload (if the local workload adjustment variable is negative) or is able to receive from communication neighbors (if the local workload adjustment variable is positive). When the local workload adjustment variable is positive, the indicated amount of workload to be offloaded is referred to herein as excess workload of the local compute device. When the local workload adjustment variable is negative, the indicated amount of additional workload that can be received is referred to herein as excess capacity of the local compute device. In some examples, the workload analyzing circuitry 1006 evaluates Equation 4 by dividing the local workload adjustment variable by the number of communication neighbor compute devices to determine the neighbor-specific workload adjustment variable (vⱼ[k]). The neighbor-specific workload adjustment variable is an indication of the amount of workload the local compute device seeks to offload or may accept from any given communication neighbor. In some examples where the local compute device is seeking to offload some workload (e.g., the local workload adjustment variable of Equation 3 is negative), the workload analyzing circuitry 1006 identifies specific workloads (e.g., task(s)) that may be offloaded and/or reassigned to communication neighbor compute devices. In some examples, the workload analyzing circuitry 1006 is instantiated by programmable circuitry executing workload analyzing instructions and/or configured to perform operations such as those represented by the flowchart of FIGS. 11A and 11B.

In some examples, the workload distribution circuitry 728 includes means for determining workload adjustment variable (e.g., excess workload or excess capacity). For example, the means for determining may be implemented by workload analyzing circuitry 1006. In some examples, the workload analyzing circuitry 1006 may be instantiated by programmable circuitry such as the example programmable circuitry 1312 of FIG. 13. For instance, the workload analyzing circuitry 1006 may be instantiated by the example microprocessor 1400 of FIG. 14 executing machine executable instructions such as those implemented by at least blocks 1112, 1114, 1128, 1132, 1140 of FIGS. 11A and 11B. In some examples, the workload analyzing circuitry 1006 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the workload analyzing circuitry 1006 may be instantiated by any other combination of hardware, software, and/or firmware. For example, the workload analyzing circuitry 1006 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example workload distribution circuitry 410 is provided with the example offload request management circuitry 1008 to generate one or more task offloading request(s) in response to the workload analyzing circuitry 1006 determining that there is excess workload of the local compute device to be offloaded or redistributed to communication neighbor compute devices. In some examples, such task offloading requests include an indication of the specific workload(s) and/or task(s) to be offloaded as identified by the workload analyzing circuitry 1006. In some examples, the offload request management circuitry 1008 identifies the specific workloads and/or task(s) to be indicated in the task offloading requests instead of the example workload analyzing circuitry 1006. In some examples, the offload request management circuitry 1008 causes the example communications interface circuitry 1002 to transmit the task offloading requests to the relevant communication neighbor compute devices and then determines whether such task offloading requests are accepted based on a reply from the relevant communication neighbor. If a task offloading request is accepted, the example offload request management circuitry 1008 transfers the task to the recipient compute device. If a task offloading request is rejected, the example offload request management circuitry 1008 causes the local compute device to retain the associated workload(s) and/or task(s).

In some examples, the offload request management circuitry 1008 also analyzes task offloading requests received from communication neighbor compute devices to determine whether such requests can be accepted. In some examples, this determination is made based on whether the task(s) indicated within the request can be assumed within the available excess capacity of the local compute device, as determined by the workload analyzing circuitry 1006. More particularly, in some examples, the offload request management circuitry 1008 compares the tasks indicated in the received request with the neighbor-specific workload adjustment variable as calculated in Equation 4 (which corresponds to the total excess capacity divided by the number of communication neighbors). In some examples, the tasks indicated in a received task offloading request are compared relative to the total excess capacity without dividing by the number of communication neighbors. In some examples, the local compute device may have sufficient excess capacity to take on the tasks from some requests from some communication neighbor compute devices but not from others. In such examples, the offload request management circuitry 1008 accepts the tasks it can and rejects the rest by sending a suitable reply to each of the received requests and then causing the local compute device to begin executing the designated task(s) that were accepted. In some examples, the offload request management circuitry 1008 is instantiated by programmable circuitry executing offload request management instructions and/or configured to perform operations such as those represented by the flowchart of FIGS. 11A and 11B.

In some examples, the workload distribution circuitry 728 includes means for managing, generating, and/or responding to task offloading requests. For example, the means for managing, generating, and/or responding may be implemented by offload request management circuitry 1008. In some examples, the offload request management circuitry 1008 may be instantiated by programmable circuitry such as the example programmable circuitry 1312 of FIG. 13. For instance, the offload request management circuitry 1008 may be instantiated by the example microprocessor 1400 of FIG. 14 executing machine executable instructions such as those implemented by at least blocks 1114, 1118, 1120, 1122, 1124, 1130, 1132, 1134, 1136, 1138 of FIGS. 11A and 11B. In some examples, the offload request management circuitry 1008 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the offload request management circuitry 1008 may be instantiated by any other combination of hardware, software, and/or firmware. For example, the offload request management circuitry 1008 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the workload distribution circuitry 728 of FIGS. 7 and/or 9 is illustrated in FIG. 10, one or more of the elements, processes, and/or devices illustrated in FIG. 10 may be combined, divided, re-arranged, omitted, eliminated, and/or implemented in any other way. Further, the example communications interface circuitry 1002, the example temperature data analyzing circuitry 1004, the example workload analyzing circuitry 1006, the example offload request management circuitry 1008, and/or, more generally, the example workload distribution circuitry 728 of FIG. 10, may be implemented by hardware alone or by hardware in combination with software and/or firmware. Thus, for example, any of the example communications interface circuitry 1002, the example temperature data analyzing circuitry 1004, the example workload analyzing circuitry 1006, the example offload request management circuitry 1008, and/or, more generally, the example workload distribution circuitry 728, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example workload distribution circuitry 728 of FIG. 10 may include one or more elements, processes, and/or devices in addition to, or instead of, those illustrated in FIG. 10, and/or may include more than one of any or all of the illustrated elements, processes and devices.

A flowchart representative of example machine readable instructions, which may be executed by programmable circuitry to implement and/or instantiate the workload distribution circuitry 728 of FIG. 10 and/or representative of example operations which may be performed by programmable circuitry to implement and/or instantiate the workload distribution circuitry 728 of FIG. 10, is shown in FIGS. 11A and 11B. The machine readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world.

FIGS. 11A and 11B show a flowchart representative of example machine readable instructions and/or example operations 1100 that may be executed, instantiated, and/or performed by programmable circuitry to determine and control the distribution of workloads across multiple communicatively coupled compute devices (e.g., servers and/or operating components within such servers) based on temperature data associated with the compute devices. In the context of this flowchart, the “local compute device” corresponds to the compute device implementing the workload distribution circuitry 728 of FIGS. 7 and/or 9 and the “communication neighbor compute devices” are the compute devices to which the local compute device is directly communicatively coupled. That said, it should be understood that the communication neighbor compute devices also implement separate instances of the workload distribution circuitry 728 by executing the operations 1100 of FIGS. 11A and 11B in parallel with the local compute device.

The example machine-readable instructions and/or the example operations 1100 of FIGS. 11A and 11B begin at block 1102, at which the example communications interface circuitry 1002 obtains a current temperature of the local compute device. That is, the communications interface circuitry 1002 receives an output from the temperature sensor(s) 726 associated with the compute device. In some examples, when there is more than one temperature sensor 726, the example temperature data analyzing circuitry 1004 determines an average of the measured temperatures. In other examples, the average temperature can be determined external to the workload distribution circuitry 728 with the result being provided to the example communications interface circuitry 1002.

At block 1104, the example communications interface circuitry 1002 transmits the current temperature (of the local compute device) to the communication neighbor compute device(s). At block 1106, the example communications interface circuitry 1002 obtains the temperature of the communication neighbor compute device(s). In some examples, the temperature(s) of the communication neighbor compute device(s) are provided from the neighbor compute devices as these other compute device(s) implement block 1104 in parallel with the local compute device.

At block 1108, the example temperature data analyzing circuitry 1004 determines whether the current temperature of the local compute device is higher than an average temperature of all communication neighbor compute devices. In some examples, this is determined based on whether the summation term in Equation 3 evaluates to a positive or negative value. If the current temperature of the local compute device is higher than the average temperature of all communication neighbor compute devices, this is an indication that the local compute device should offload some of its workload to balance out the temperatures of the connected compute devices. Accordingly, control advances to block 1110 where the example workload distribution circuitry 728 seeks to offload tasks to cooler communication neighbor compute devices. FIG. 11B provides further detail regarding the implementation of block 1110.

Turning to FIG. 11B, at block 1112, the temperature data analyzing circuitry 1004 and/or the example workload analyzing circuitry 1006 determines the total excess workload to be redistributed from the local compute device to the communication neighbor compute device(s). In some examples, this is determined by evaluating the entire expression of Equation 3. Thereafter, at block 1114, the example workload analyzing circuitry 1006 and/or the example offload request management circuitry 1008 generates a task offloading request for each communication neighbor compute device based on the total excess workload. In some examples, the task offloading requests are generated by first determining the amount of workload(s) and/or task(s) to be provided to each communication neighbor compute device. In some examples, this is determined by the workload analyzing circuitry 1006 evaluating Equation 4 as outlined above by dividing the total excess workload by the number of communication neighbor compute devices. Once the amount of workload(s) and/or task(s) to be identified for communication neighbor compute device is known, the example offload request management circuitry 1008 can generate each task offloading request with an identification of the relevant workload(s) and/or task(s).

At block 1116, the example offload request management circuitry 1008 uses the communications interface circuitry 1002 to transmit a task offloading request to a given communication neighbor compute device. At block 1118, the offload request management circuitry 1008 determines whether the task offloading request was accepted by the given communication neighbor compute device. In some examples, this is determined based on a reply received from the communication neighbor compute device. If the request is accepted, control advances to block 1120 where the example offload request management circuitry 1008 transfers the task(s) designated in the task offloading request to the communication neighbor compute device. Thereafter, control advances to block 1124 where the example offload request management circuitry 1008 determines whether there is a request to be sent to another communication neighbor compute device. If so, control returns to block 1116 to transmit the associated task offloading request.

Returning to block 1118, if the task offloading request is not accepted (e.g., the request is rejected), control advances to block 1122 where the offload request management circuitry 1008 retains the task(s) designated in the task offloading request for execution by the local compute device. Thereafter, control again advances to block 1124. If, at block 1124, the example offload request management circuitry 1008 determines there are no more requests to be sent, control advances to block 1130 in FIG. 11A discussed further below.

Returning to block 1108 shown in FIG. 11A, if the example temperature data analyzing circuitry 1004 determines the current temperature of the local compute device is not higher than the average temperature of all communication neighbor compute devices, control advances to block 1128. At block 1128, the example workload analyzing circuitry 1006 determines the excess capacity of the local compute device. The excess capacity is an indication of the amount of additional workload(s) and/or task(s) the local compute device can receive from one or more of the communication neighbor compute devices. In some examples, the excess capacity is determined by evaluating the entire expression of Equation 3.

At block 1130, the example communications interface circuitry 1002 and/or the offload request management circuitry 1008 determines whether task offloading request(s) have been received from the communication neighbor compute device(s). If not, control advances directly to block 1140. If a task offloading request has been received, control advances to block 1132 where the example workload analyzing circuitry 1006 and/or the offload request management circuitry 1008 determines whether the task offloading request can be accepted without exceeding the capacity of the local compute device. The local compute device has sufficient capacity if the task(s) designated in the request are less than the excess capacity determined at block 1128. In such examples, control advances to block 1134 where the example offload request management circuitry 1008 accepts the task(s) designated in the task offloading request. In some examples, the task(s) are accepted by causing transmission (via the communications interface circuitry 1002) of a reply indicating acceptance and then taking on the designated task(s). Thereafter, control advances to block 1138 where the example offload request management circuitry 1008 determines whether there is another task offloading request received? If so, control returns to block 1132. Otherwise, control advances to block 1140.

Returning to block 1132, if the task offloading request cannot be accepted (e.g., the designated task(s) exceed the excess capacity of the local compute device or the local compute device does not have excess capacity but has an excess workload instead), control advances to block 1136. At block 1136, the example offload request management circuitry 1008 rejects the task(s) designated in the task offloading request. In some examples, the task(s) are rejected by causing transmission (via the communications interface circuitry 1002) of a reply indicating the task(s) cannot be accepted. Thereafter, control advances to block 1138 as discussed above.

At block 1140, the workload analyzing circuitry 1006 determines whether to update the workload balancing analysis. In some examples, the analysis is updated at any suitable interval of time. If the analysis is to be updated, control returns to block 1102 to repeat the process. Otherwise, the example flowchart of FIGS. 11A and 11B ends.

The program(s) represented in FIGS. 6, 11A, and/or 11B may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program(s) are described with reference to the flowcharts illustrated in FIGS. 6, 11A, and/or 11B, many other methods of implementing the example workload distribution circuitry 410, 728 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6, 11A, and 11B may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 12 is a block diagram of an example programmable circuitry platform 1200 structured to execute and/or instantiate the example machine-readable instructions and/or the example operations of FIG. 6 to implement the workload distribution circuitry 410 of FIG. 5. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, VPUs, DSPs, and/or microcontrollers from any desired family or manufacturer. The programmable circuitry 1212 may be implemented by one or more semiconductor based (e.g., silicon based) devices. In this example, the programmable circuitry 1212 implements the example communications interface circuitry 502, the example temperature data processing circuitry 504, the example thermal weight determining circuitry 506, and the example load balancing circuitry 508.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1232, which may be implemented by the machine readable instructions of FIG. 6, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example programmable circuitry platform 1300 structured to execute and/or instantiate the example machine-readable instructions and/or the example operations of FIGS. 11A, and 11B to implement the workload distribution circuitry 728 of FIG. 10. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, VPUs, DSPs, and/or microcontrollers from any desired family or manufacturer. The programmable circuitry 1312 may be implemented by one or more semiconductor based (e.g., silicon based) devices. In this example, the programmable circuitry 1312 implements example communications interface circuitry 1002, the example temperature data analyzing circuitry 1004, the example workload analyzing circuitry 1006, and the example offload request management circuitry 1008.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1332, which may be implemented by the machine readable instructions of FIGS. 11A, and 11B, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1212, 1312 of FIGS. 12 and/or 13. In this example, the programmable circuitry 1212, 1312 of FIGS. 12 and/or 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 6, 11A, and 11B to effectively instantiate the circuitry of FIGS. 5 and/or 10 as logic circuits to perform operations corresponding to those machine readable instructions. In some such examples, the circuitry of FIGS. 5 and/or 10 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 6, 11A, and 11B.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1214, 1216, 1314, 1316 of FIGS. 12 and 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1212, 1312 of FIGS. 12 and/or 13. In this example, the programmable circuitry 1212, 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowchart(s) of FIGS. 6, 11A, and 11B but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6, 11A, and 11B. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6, 11A, and 11B. As such, the FPGA circuitry 1500 may be configured and/or structured to effectively instantiate some or all of the operations/functions corresponding to the machine readable instructions of the flowchart(s) of FIGS. 6, 11A, and 11B as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 6, 11A, and 11B faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 6, 11A, and 11B and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1212, 1312 of FIGS. 12 and/or 13, many other approaches are contemplated. For example, FPGA circuitry may include an on-board CPU, such as one or more of the example CPU 1520 of FIG. 14. Therefore, the programmable circuitry 1212, 1312 of FIGS. 12 and/or 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine readable instructions represented by the flowchart(s) of FIGS. 6, 11A, and 11B to perform first operation(s)/function(s), the FPGA circuitry 1500 of FIG. 15 may be configured and/or structured to perform second operation(s)/function(s) corresponding to a second portion of the machine readable instructions represented by the flowcharts of FIG. FIGS. 6, 11A, and 11B, and/or an ASIC may be configured and/or structured to perform third operation(s)/function(s) corresponding to a third portion of the machine readable instructions represented by the flowcharts of FIGS. 6, 11A, and 11B.

It should be understood that some or all of the circuitry of FIGS. 5 and/or 10 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIGS. 5 and/or 10 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIGS. 5 and/or 10 may be implemented within one or more virtual machines and/or containers executing on the microprocessor 1400 of FIG. 14.

In some examples, the programmable circuitry 1212, 1312 of FIGS. 12 and/or 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1212, 1312 of FIGS. 12 and/or 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

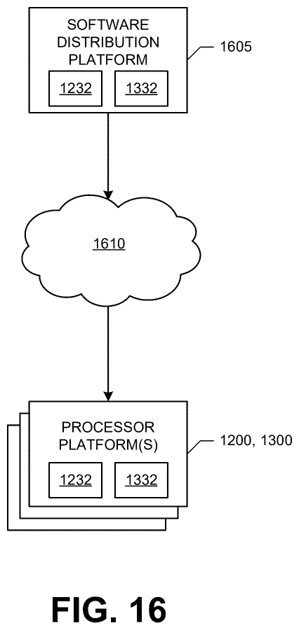

A block diagram illustrating an example software distribution platform 1605 to distribute software such as the example machine readable instructions 1232, 1332 of FIGS. 12 and/or 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1232, 1332 of FIGS. 12 and/or 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1232, 1332, which may correspond to the example machine readable instructions of FIGS. 6, 11A, and 11B, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232, 1332 from the software distribution platform 1605. For example, the software, which may correspond to the example machine readable instructions of FIG. FIGS. 6, 11A, and 11B, may be downloaded to the example programmable circuitry platform 1200, 1300, which is to execute the machine readable instructions 1232, 1332 to implement the workload distribution circuitry 410, 728 of FIGS. 5 and/or 10. In some examples, one or more servers of the software distribution platform 1605 periodically offer, transmit, and/or force updates to the software (e.g., the example machine readable instructions 1232, 1332 of FIGS. 12 and/or 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that balance or distribute workloads between servers in a server cluster, between operating components of such servers, and/or other electronic devices in a manner that takes into account the temperature of such servers, operating components, and/or other electronic devices over time. By taking temperature into account, the servers, the operating components, and/or the other electronic devices can be controlled to operate at a substantially consistent temperature, which helps to improve the reliability and longevity of the servers, operating components, and/or other electronic devices. In some examples, this is achieved by a central load balancing controller that aggregates temperature data from the environment (e.g., from different servers, operating components, and/or other electronic devices) and uses that data to determine how to assign and/or reassign workloads. In other examples, each individual server and/or operating component shares its temperature with communication neighbor(s) and uses the temperatures obtained from the neighboring server(s) to determine whether to seek to offload excess workload or accept additional workload based on available excess capacity. In this manner, the balancing of workloads across the servers and/or operating components can be achieved in a decentralized manner, thereby avoiding potential single point failures. Such a decentralized approach is applicable to any suitable topology and scalable to any suitable size of nodes in an associated collection of servers and/or operating components.

Further examples and combinations thereof include the following:

Example 1 includes a first compute device comprising interface circuitry, machine readable instructions, and at least one programmable circuit to at least one of instantiate or execute the machine readable instructions to analyze temperature data indicative of a first temperature of the first compute device and a second temperature of a second compute device, and cause an adjustment in at least one of (a) a first workload executed by the first compute device or a second workload executed by the second compute device based on the analysis of both the first temperature and the second temperature or (b) a second workload executed by the second compute device based on the analysis of both the first temperature and the second temperature, the adjustment to reduce a difference between the first and second temperatures.

Example 2 includes any of the preceding clause(s) of example 1, wherein the first compute device is a first server in a server cluster and the second compute device is a second server in a server cluster.

Example 3 includes any of the preceding clause(s) of any one or more of examples 1-2, wherein the first compute device is a first operating component of a server and the second compute device is a second operating component of the server.

Example 4 includes any of the preceding clause(s) of any one or more of examples 1-3, wherein one or more of the at least one programmable circuit is to determine first and second weighted values for the respective first and second compute devices based on the temperature data, the adjustment based on the first and second weighted values.

Example 5 includes any of the preceding clause(s) of any one or more of examples 1-4, wherein one or more of the at least one programmable circuit is to generate a thermal weight matrix that includes the first and second weighted values, the thermal weight matrix including rows and columns according to a physical arrangement of a plurality of interconnected compute devices, the plurality of interconnected compute devices includes the first and second compute devices.

Example 6 includes any of the preceding clause(s) of any one or more of examples 1-5, wherein one or more of the at least one programmable circuit is to execute a neural network to generate the weighted values.

Example 7 includes any of the preceding clause(s) of any one or more of examples 1-6, wherein the first temperature is based on a first measurement by a first temperature sensor associated with the first compute device and the second temperature is based on a second measurement by a second temperature sensor associated with the second compute device.

Example 8 includes any of the preceding clause(s) of any one or more of examples 1-7, wherein the temperature data is based on a thermographic image of the first and second compute devices captured by a thermal camera.

Example 9 includes any of the preceding clause(s) of any one or more of examples 1-8, wherein one or more of the at least one programmable circuit is to determine a first workload adjustment value for the first compute device, the first workload adjustment value based on a difference between the first temperature and the second temperature.

Example 10 includes any of the preceding clause(s) of any one or more of examples 1-9, wherein the first workload adjustment value is to indicate an excess workload of the first compute device when the first temperature is higher than an average temperature of one or more other compute devices in direct communication with the first compute device, the one or more other compute devices including the second compute device.

Example 11 includes any of the preceding clause(s) of any one or more of examples 1-10, wherein one or more of the at least one programmable circuit is to generate a task offloading request based on the excess workload, the task offloading request to designate a task to be offloaded to the second compute device, cause transmission of the task offloading request to the second compute device, transfer the task to the second compute device when the second compute device accepts the task offloading request, and retain the task at the first compute device when the second compute device rejects the task offloading request.

Example 12 includes any of the preceding clause(s) of any one or more of examples 1-11, wherein a workload amount designated in the task offloading request corresponds to the excess workload divided by a number of the one or more other compute devices.

Example 13 includes any of the preceding clause(s) of any one or more of examples 1-12, wherein the first workload adjustment value is to indicate an excess capacity of the first compute device when the first temperature is lower than an average temperature of one or more other compute device in direct communication with the first compute device, the one or more other compute devices including the second compute device.

Example 14 includes any of the preceding clause(s) of any one or more of examples 1-13, wherein one or more of the at least one programmable circuit is to accept a task offloading request from the second compute device when a workload amount designated in the task offloading request is less than the excess capacity, and reject the task offloading request when the workload amount is greater than the excess capacity.

Example 15 includes any of the preceding clause(s) of any one or more of examples 1-14, wherein at least one of the one or more other compute devices is in direct communication with an additional compute device, the first compute device not in direct communication with the additional compute device.

Example 16 includes a method comprising analyzing temperature data indicative of a first temperature of a first compute device and a second temperature of a second compute device, and causing, by executing instructions on the first compute device, an adjustment in at least one of (a) a first workload executed by the first compute device or a second workload executed by the second compute device based on the analysis of both the first temperature and the second temperature or (b) a second workload executed by the second compute device based on the analysis of both the first temperature and the second temperature, the adjustment to reduce a difference between the first and second temperatures.

Example 17 includes any of the preceding clause(s) of example 16, wherein the first compute device is a first server in a server cluster and the second compute device is a second server in a server cluster.

Example 18 includes any of the preceding clause(s) of any one or more of examples 16-17, wherein the first compute device is a first operating component of a server and the second compute device is a second operating component of the server.

Example 19 includes any of the preceding clause(s) of any one or more of examples 16-18, including determining first and second weighted values for the respective first and second compute devices based on the temperature data, the adjustment based on the first and second weighted values.

Example 20 includes any of the preceding clause(s) of any one or more of examples 16-19, including generating a thermal weight matrix that includes the first and second weighted values, the thermal weight matrix including rows and columns according to a physical arrangement of a plurality of interconnected compute devices, the plurality of interconnected compute devices includes the first and second compute devices.

Example 21 includes any of the preceding clause(s) of any one or more of examples 16-20, including executing a neural network to generate the weighted values.

Example 22 includes any of the preceding clause(s) of any one or more of examples 16-21, wherein the first temperature is based on a first measurement by a first temperature sensor associated with the first compute device and the second temperature is based on a second measurement by a second temperature sensor associated with the second compute device.

Example 23 includes any of the preceding clause(s) of any one or more of examples 16-22, wherein the temperature data is based on a thermographic image of the first and second compute devices captured by a thermal camera.

Example 24 includes any of the preceding clause(s) of any one or more of examples 16-23, including determining a first workload adjustment value for the first compute device, the first workload adjustment value based on a difference between the first temperature and the second temperature.

Example 25 includes any of the preceding clause(s) of any one or more of examples 16-24, wherein the first workload adjustment value is to indicate an excess workload of the first compute device when the first temperature is higher than an average temperature of one or more other compute devices in direct communication with the first compute device, the one or more other compute devices including the second compute device.

Example 26 includes any of the preceding clause(s) of any one or more of examples 16-25, including generate a task offloading request based on the excess workload, the task offloading request to designate a task to be offloaded to the second compute device, cause transmission of the task offloading request to the second compute device, transfer the task to the second compute device when the second compute device accepts the task offloading request, and retain the task at the first compute device when the second compute device rejects the task offloading request.

Example 27 includes any of the preceding clause(s) of any one or more of examples 16-26, wherein a workload amount designated in the task offloading request corresponds to the excess workload divided by a number of the one or more other compute devices.

Example 28 includes any of the preceding clause(s) of any one or more of examples 16-27, wherein the first workload adjustment value is to indicate an excess capacity of the first compute device when the first temperature is lower than an average temperature of one or more other compute device in direct communication with the first compute device, the one or more other compute devices including the second compute device.

Example 29 includes any of the preceding clause(s) of any one or more of examples 16-28, including accept a task offloading request from the second compute device when a workload amount designated in the task offloading request is less than the excess capacity, and reject the task offloading request when the workload amount is greater than the excess capacity.

Example 30 includes any of the preceding clause(s) of any one or more of examples 16-29, wherein at least one of the one or more other compute devices is in direct communication with an additional compute device, the first compute device not in direct communication with the additional compute device.

Example 31 includes an apparatus comprising means to perform a method of any one of examples 16-30.

Example 32 includes machine-readable storage including machine-readable instructions, when executed, to implement a method or realize an apparatus as set forth in any preceding example.

Example 33 includes a non-transitory machine readable storage medium comprising instructions to cause a first compute device to at least analyze temperature data indicative of a first temperature of the first compute device and a second temperature of a second compute device, and cause an adjustment in at least one of (a) a first workload executed by the first compute device or a second workload executed by the second compute device based on the analysis of both the first temperature and the second temperature or (b) a second workload executed by the second compute device based on the analysis of both the first temperature and the second temperature, the adjustment to reduce a difference between the first and second temperatures.

Example 34 includes any of the preceding clause(s) of example 33, wherein the first compute device is a first server in a server cluster and the second compute device is a second server in a server cluster.

Example 35 includes any of the preceding clause(s) of any one or more of examples 33-34, wherein the first compute device is a first operating component of a server and the second compute device is a second operating component of the server.

Example 36 includes any of the preceding clause(s) of any one or more of examples 33-35, wherein the instructions cause the first compute device to determine first and second weighted values for the respective first and second compute devices based on the temperature data, the adjustment based on the first and second weighted values.

Example 37 includes any of the preceding clause(s) of any one or more of examples 33-36, wherein the instructions cause the first compute device to generate a thermal weight matrix that includes the first and second weighted values, the thermal weight matrix including rows and columns according to a physical arrangement of a plurality of interconnected compute devices, the plurality of interconnected compute devices includes the first and second compute devices.

Example 38 includes any of the preceding clause(s) of any one or more of examples 33-37, wherein the instructions cause the first compute device to execute a neural network to generate the weighted values.

Example 39 includes any of the preceding clause(s) of any one or more of examples 33-38, wherein the first temperature is based on a first measurement by a first temperature sensor associated with the first compute device and the second temperature is based on a second measurement by a second temperature sensor associated with the second compute device.

Example 40 includes any of the preceding clause(s) of any one or more of examples 33-39, wherein the temperature data is based on a thermographic image of the first and second compute devices captured by a thermal camera.

Example 41 includes any of the preceding clause(s) of any one or more of examples 33-40, wherein the instructions cause the first compute device to determine a first workload adjustment value for the first compute device, the first workload adjustment value based on a difference between the first temperature and the second temperature.

Example 42 includes any of the preceding clause(s) of any one or more of examples 33-41, wherein the first workload adjustment value is to indicate an excess workload of the first compute device when the first temperature is higher than an average temperature of one or more other compute devices in direct communication with the first compute device, the one or more other compute devices including the second compute device.

Example 43 includes any of the preceding clause(s) of any one or more of examples 33-42, wherein the instructions cause the first compute device to generate a task offloading request based on the excess workload, the task offloading request to designate a task to be offloaded to the second compute device, cause transmission of the task offloading request to the second compute device, transfer the task to the second compute device when the second compute device accepts the task offloading request, and retain the task at the first compute device when the second compute device rejects the task offloading request.

Example 44 includes any of the preceding clause(s) of any one or more of examples 33-43, wherein a workload amount designated in the task offloading request corresponds to the excess workload divided by a number of the one or more other compute devices.

Example 45 includes any of the preceding clause(s) of any one or more of examples 33-44, wherein the first workload adjustment value is to indicate an excess capacity of the first compute device when the first temperature is lower than an average temperature of one or more other compute device in direct communication with the first compute device, the one or more other compute devices including the second compute device.

Example 46 includes any of the preceding clause(s) of any one or more of examples 33-45, wherein the instructions cause the first compute device to accept a task offloading request from the second compute device when a workload amount designated in the task offloading request is less than the excess capacity, and reject the task offloading request when the workload amount is greater than the excess capacity.

Example 47 includes any of the preceding clause(s) of any one or more of examples 33-46, wherein at least one of the one or more other compute devices is in direct communication with an additional compute device, the first compute device not in direct communication with the additional compute device.

Example 48 includes a server cluster comprising a first server, a first temperature sensor to measure a first temperature of the first server, a second server, and a second temperature sensor to measure a second temperature of the second server, the second server to provide the second temperature to the first server, the first server to cause a change to a workload of the first server based on both the first temperature and the second temperature.

Example 49 includes any of the preceding clause(s) of example 48, wherein the change to the workload is a first change to a first workload, the first server is to provide the first temperature to the second server, and the second server is to cause a second change to a second workload of the second server based on the first and second temperatures.

Example 50 includes any of the preceding clause(s) of any one or more of examples 48-49, wherein the first change in the first workload includes transferring a task from the first server to the second server in response to a determination by the first server that the first temperature is higher than the second temperature, and the second change in the second workload includes accepting the task from the first server in response to a determination by the second server that the first temperature is higher than the second temperature.

Example 51 includes any of the preceding clause(s) of any one or more of examples 48-50, wherein the first and second servers are in a same rack.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A first compute device comprising:
interface circuitry;
machine readable instructions; and
at least one programmable circuit to at least one of instantiate or execute the machine readable instructions to:
analyze temperature data indicative of a first temperature of the first compute device and a second temperature of a second compute device; and
cause an adjustment in at least one of (a) a first workload executed by the first compute device or a second workload executed by the second compute device based on the analysis of both the first temperature and the second temperature or (b) a second workload executed by the second compute device based on the analysis of both the first temperature and the second temperature, the adjustment to reduce a difference between the first and second temperatures.

2. The first compute device of claim 1, wherein the first compute device is a first server in a server cluster and the second compute device is a second server in a server cluster.

3. The first compute device of claim 1, wherein the first compute device is a first operating component of a server and the second compute device is a second operating component of the server.

4. The first compute device of claim 1, wherein one or more of the at least one programmable circuit is to determine first and second weighted values for the respective first and second compute devices based on the temperature data, the adjustment based on the first and second weighted values.

5. The first compute device of claim 4, wherein one or more of the at least one programmable circuit is to generate a thermal weight matrix that includes the first and second weighted values, the thermal weight matrix including rows and columns according to a physical arrangement of a plurality of interconnected compute devices, the plurality of interconnected compute devices includes the first and second compute devices.

6. The first compute device of claim 4, wherein one or more of the at least one programmable circuit is to execute a neural network to generate the weighted values.

7. The first compute device of claim 1, wherein the first temperature is based on a first measurement by a first temperature sensor associated with the first compute device and the second temperature is based on a second measurement by a second temperature sensor associated with the second compute device.

8. The first compute device of claim 1, wherein the temperature data is based on a thermographic image of the first and second compute devices captured by a thermal camera.

9. The first compute device of claim 1, wherein one or more of the at least one programmable circuit is to determine a first workload adjustment value for the first compute device, the first workload adjustment value based on a difference between the first temperature and the second temperature.

10. The first compute device of claim 9, wherein the first workload adjustment value is to indicate an excess workload of the first compute device when the first temperature is higher than an average temperature of one or more other compute devices in direct communication with the first compute device, the one or more other compute devices including the second compute device.

11. The first compute device of claim 10, wherein one or more of the at least one programmable circuit is to:
generate a task offloading request based on the excess workload, the task offloading request to designate a task to be offloaded to the second compute device;
cause transmission of the task offloading request to the second compute device;
transfer the task to the second compute device when the second compute device accepts the task offloading request; and
retain the task at the first compute device when the second compute device rejects the task offloading request.

12. The first compute device of claim 11, wherein a workload amount designated in the task offloading request corresponds to the excess workload divided by a number of the one or more other compute devices.

13. The first compute device of claim 9, wherein the first workload adjustment value is to indicate an excess capacity of the first compute device when the first temperature is lower than an average temperature of one or more other compute device in direct communication with the first compute device, the one or more other compute devices including the second compute device.

14. The first compute device of claim 13, wherein one or more of the at least one programmable circuit is to:
accept a task offloading request from the second compute device when a workload amount designated in the task offloading request is less than the excess capacity; and
reject the task offloading request when the workload amount is greater than the excess capacity.

15. The first compute device of claim 13, wherein at least one of the one or more other compute devices is in direct communication with an additional compute device, the first compute device not in direct communication with the additional compute device.

16. A non-transitory machine readable storage medium comprising instructions to cause a first compute device to at least:
analyze temperature data indicative of a first temperature of the first compute device and a second temperature of a second compute device; and
cause an adjustment in at least one of (a) a first workload executed by the first compute device based on the analysis of both the first temperature and the second temperature or (b) a second workload executed by the second compute device based on the analysis of both the first temperature and the second temperature, the adjustment to reduce a difference between the first and second temperatures.

17. The non-transitory machine readable storage medium of claim 16, wherein the instructions cause the first compute device to determine a first workload adjustment value for the first compute device, the first workload adjustment value based on a difference between the first temperature and the second temperature.

18. A server cluster comprising:
a first server;
a first temperature sensor to measure a first temperature of the first server;
a second server; and
a second temperature sensor to measure a second temperature of the second server, the second server to provide the second temperature to the first server, the first server to cause a change to a workload of the first server based on both the first temperature and the second temperature.

19. The server cluster of claim 18, wherein the change to the workload is a first change to a first workload, the first server is to provide the first temperature to the second server, and the second server is to cause a second change to a second workload of the second server based on the first and second temperatures.

20. The server cluster of claim 19, wherein the first change in the first workload includes transferring a task from the first server to the second server in response to a determination by the first server that the first temperature is higher than the second temperature, and the second change in the second workload includes accepting the task from the first server in response to a determination by the second server that the first temperature is higher than the second temperature.
